(19) United States
(12) Patent Application Publication
(10) Pub. No.: US 2026/0050879 A1
(43) Pub. Date: Feb. 19, 2026

(54) SYSTEM AND METHOD FOR INTELLIGENT DYNAMIC MARKETPLACE

(71) Applicant: Falconet Solutions, Inc., Menlo Park, CA (US)

(72) Inventor: Baris Karadogan, Menlo Park, CA (US)

(21) Appl. No.: 19/267,518

(22) Filed: Jul. 12, 2025

Related U.S. Application Data
(60) Provisional application No. 63/682,835, filed on Aug. 14, 2024.

(51) Int. Cl. G06Q 10/083; G06Q 30/0202

(52) U.S. Cl. CPC G06Q 10/08355; G06Q 30/0202

(57) ABSTRACT

A dynamic marketplace system leveraging store and warehouse mobility features a neuroevolution (NE) engine, an electronic device, and a request handler facilitating communication between the electronic device and the NE engine. The NE engine interfaces with a data storage system and an event handler receiving real-time event data from a public cloud services processor. An intentions handler interprets user intention data to predict user behavior. The NE engine, integrated with a processor, generates a predictive evolutionary model for the marketplace based on request, event, and intention data. An AI agent processor within the NE engine creates a recommendation model for mobile retail vendors, devises route plans, and deploys vendors to strategic locations.

### CROSS-REFERENCE TO RELATED APPLICATIONS

This application is a U.S. Non-Provisional Utility Patent Application entitled, “SYSTEM AND METHOD FOR INTELLIGENT DYNAMIC MARKETPLACE” which claims priority to co-pending U.S. Provisional Ser. No. 63/682,835, filed on Aug. 14, 2024 entitled, “SYSTEM AND METHOD FOR INTELLIGENT DYNAMIC MARKETPLACE” the contents of which are hereby fully incorporated by reference.

### BACKGROUND

Generally, mobile grocery stores, also known as Grocery Trucks (GTs) or pop-up grocery stores, have emerged as a new trend in the retail industry. GTs typically stock a wide variety of fresh fruits and vegetables and other grocery items. They are usually equipped with refrigeration units to keep the food fresh and have a payment system for customers to buy the products. These mobile stores bring convenience and accessibility to customers in under-served or rural areas or areas where traditional brick-and-mortar grocery stores are absent. The trend of grocery trucks is expected to grow in the coming years as more and more people look for ways to improve access to healthy food in their communities. In the U.S., the mobile food vendors market is valued at 1.16 billion dollars in 2021. It is predicted to grow at a rate of 6.4% annually from 2022 to 2030, driven by the increasing trend of culinary arts and the preference of young people for different dining experiences over traditional dining in restaurants.

Another application of GTs is to provide food to people in emergencies, such as natural disasters or power outages, and address food insecurity by increasing access to healthy food options. GTs are valuable resources for alleviating food insecurity, and these trucks are often operated by non-profit organizations, local governments, and community groups that want to address food insecurity and promote healthy eating. Logistics for mobile grocery stores refer to planning, coordinating, and controlling the movement and storage of goods, services, and information from the point of origin to the point of consumption. This includes transportation, inventory management, warehousing, and distribution of products. In the case of mobile grocery stores, logistics also includes the planning and coordination of the routes and schedule of the mobile store, as well as the management of the supply chain and inventory. This includes sourcing products from suppliers, managing inventory levels, restocking the mobile store as needed, and coordinating delivery schedules. Effective logistics management can impact delivery times, cost, and overall customer satisfaction. By optimizing logistics, mobile grocery store owners and operators can improve their business by reducing costs and increasing efficiency, ultimately resulting in better customer service. Current solutions that aim to solve this problem are rigid and do not vary quickly based on the real-time dynamic marketplace behavior and optimization needs.

### SUMMARY OF THE INVENTION

The implementation of competitive evolution in an intelligent dynamic market place such as, mobile grocery store, involves an approach to planning, coordinating, and controlling the movement and storage of goods, services, and information from the point of origin to the point of consumption. This approach aims to generate a real-time ROI-optimized dynamic marketplace based on user interaction patterns, referred to as indentation. In the context of mobile grocery stores, competitive evolution leverages advanced algorithms inspired by natural selection to optimize various logistics and operational strategies continuously. By simulating the competition among different strategies for inventory management, route planning, and customer engagement, to name a few examples, the system selects the most effective approaches that maximize return on investment (ROI). To achieve this, the process begins with comprehensive data collection on customer behaviors, preferences, and interaction patterns within the mobile grocery environment. This data may include, but not be limited to, metrics such as purchase frequency, time spent browsing, and/or responsiveness to promotions. The competitive evolution algorithms then process this data to evaluate the performance of different strategies, such as varying inventory levels, adjusting delivery routes, and/or modifying pricing models. Successful strategies are refined and iterated upon, while less effective ones are discarded, creating a self-optimizing loop that enhances operational efficiency and customer satisfaction.

Real-time dynamic adjustments are a component of this system, enabling the mobile grocery store to dynamically adapt to changing customer demands and market conditions. For example, if data indicates a surge in demand for specific products in a particular area, the system can optimize the supply chain to ensure timely restocking and delivery, thereby minimizing stockouts and maximizing sales. Additionally, by analyzing user indentation, the system can tailor marketing efforts and promotions to individual customers, increasing engagement and boosting ROI. In the realm of logistics, the integration of competitive evolution helps streamline the coordination of goods movement from suppliers to mobile stores and ultimately to consumers. This includes, but is not limited to, optimizing storage solutions within mobile units, ensuring efficient load distribution, and/or minimizing transit times. By continuously refining these logistical elements based on real-time data, mobile grocery stores can maintain a high level of service quality while reducing operational costs. The challenges in implementing such a system are notable, encompassing the need for robust data management infrastructure, sophisticated algorithm development, and the ability to scale operations as the user base and data volume grow. Additionally, adherence to privacy regulations is paramount, requiring careful handling of user data to maintain trust and compliance. The application of competitive evolution in mobile grocery stores represents a transformative approach to logistics and marketplace optimization. By leveraging real-time data and advanced algorithms, these stores can create a highly responsive and efficient system that enhances customer satisfaction and maximizes ROI through dynamic adaptation to user interaction patterns.

In some aspects, the techniques described herein relate to a dynamic marketplace system based on store and warehouse mobility, including: a neuroevolution (NE) engine; an electronic device; a request handler electrically connected to the electronic device and to the NE engine, and wherein the request handler to receive request data for a product from the electronic device, and wherein the request handler to transmit the request data to the NE engine; a data storage system is electrically connected to the NE engine; a public cloud services processor; an event handler electrically connected to the public cloud services processor and to the NE engine, and wherein the event handler to receive real-time event data from the public cloud services processor, and wherein the event handler to transmit the real-time event data to the NE engine; an intentions handler electrically connected to the NE engine and configured to receive intention data from a user to identify an intent of the user, and generate a probability that the user will carry out the intent based on a historical follow-through of the user, and wherein the intentions handler to transmit the intention data to the NE engine; a processor integrated with the NE engine configured to: in response to concurrently receiving the request data, the real-time event data, and the intention data, generate a predictive evolutionary model for a target market in the dynamic marketplace, the predictive evolutionary model configured to trigger one or more real-world control actions; an AI agent processor in communication with the NE engine configured to: generate a recommendation model for a first mobile retail vendor based on the predictive evolutionary model; recommend a route plan for the first mobile retail vendor; and automatically initiate deployment of the first mobile retail vendor to one or more physical locations based on the route plan, including transmitting control instructions to a dispatching system for execution.

In some aspects, the techniques described herein relate to a dynamic marketplace system based on store and warehouse mobility, wherein the AI agent processor configured to: detect a presence of a second mobile retail vendor and update a vendor database with one or more goods or services offered by the second mobile retail vendor; generate a recommendation model for the second mobile retail vendor based on an updated predictive evolutionary model; recommend an updated route plan for the second mobile retail vendor; and deploy the second mobile retail vendor based the recommendation model of the first mobile retail vendor and the updated predictive evolutionary model of the second mobile retail vendor.

In some aspects, the techniques described herein relate to a dynamic marketplace system based on store and warehouse mobility, wherein the AI agent processor is a vendor.

In some aspects, the techniques described herein relate to a dynamic marketplace system based on store and warehouse mobility, wherein the public cloud services processor to integrate one or more public events in one or more operation zones.

In some aspects, the techniques described herein relate to a dynamic marketplace system based on store and warehouse mobility, wherein the one or more public events is based on at least a traffic limitation, a transit time, or a public event.

In some aspects, the techniques described herein relate to a dynamic marketplace system based on store and warehouse mobility, wherein the data storage system to store one or more of historical data, a customer preference, a market trend, or an operational constraint.

In some aspects, the techniques described herein relate to a dynamic marketplace system based on store and warehouse mobility, wherein the AI agent processor to dynamically adjust vendor operations and recommendations based on real-time changes in user preferences, event dynamics, geographical locations, and vendor-specific performance metrics.

In some aspects, the techniques described herein relate to a dynamic marketplace system based on store and warehouse mobility, wherein the dynamic marketplace system is based on a dynamic return on a dynamic (ROI) model related to the intent of the user.

In some aspects, the techniques described herein relate to a dynamic marketplace system based on store and warehouse mobility, wherein the intent of the user is determined when the intentions handler detects an opening of one or more applications.

In some aspects, the techniques described herein relate to a dynamic marketplace system based on store and warehouse mobility, wherein the intent of the user is determined when the intentions handler detects a predetermined length of time that is spent on the product in an application.

In some aspects, the techniques described herein relate to a dynamic marketplace system based on store and warehouse mobility, wherein the intent of the user is determined when the intentions handler detects a selected future product.

In some aspects, the techniques described herein relate to a dynamic marketplace system based on store and warehouse mobility, wherein the AI agent processor to continuously update and refine the dynamic ROI model based on real-time data and historical performance metrics.

In some aspects, the techniques described herein relate to a dynamic marketplace system based on store and warehouse mobility, wherein the AI agent processor to analyze consumer intent to predict a profitable location and time for a vendor to operate.

In some aspects, the techniques described herein relate to a dynamic marketplace system based on store and warehouse mobility, wherein the AI agent processor to adjust vendor routes and schedules in response to detected changes in consumer intent.

In some aspects, the techniques described herein relate to a dynamic marketplace system based on store and warehouse mobility, further including: one or more public or private events are automatically detected and factored into the dynamic ROI model to optimize vendor placement.

In some aspects, the techniques described herein relate to a dynamic marketplace system based on store and warehouse mobility, further including: a past behavior is used to generate personalized recommendations for future product offerings and locations.

In some aspects, the techniques described herein relate to a dynamic marketplace system based on store and warehouse mobility, further including: a proximity of multi-dwelling units is considered to estimate potential customer density and optimize vendor positioning.

In some aspects, the techniques described herein relate to a dynamic marketplace system based on store and warehouse mobility, further including: a median income in a location is used to tailor product offerings and pricing strategies for vendors.

In some aspects, the techniques described herein relate to a dynamic marketplace system based on store and warehouse mobility, further including: a delivery range based on proximity selected by a vendor to influence one or more of the route plan and target locations; a vendor schedule optimized based on a time of day or night and on expected customer activity patterns; a merchandise or service type factored into the dynamic ROI model to align vendor offerings with consumer demand in one or more differing locations. a past ROI of a predetermined vendor used to refine a future recommendation or an operational strategy; and one or more real-time notifications or updates configured to be transmitted to one or more vendors based on an updated analysis of consumer intent or one or more market conditions.

In some aspects, the techniques described herein relate to a computer-implemented method for optimizing route planning and delivery in a mobile retail environment, including: receiving, by a request handler executed by a computing system, request data for a product from at least one electronic device, wherein the request data includes product type, location of the at least one electronic device, and timestamp information; transmitting the request data to a neuroevolution (NE) engine, the NE engine configured to evolve neural network topologies using genetic algorithms, including: encoding a plurality of candidate neural network topologies as digital chromosomes including connection weights and node configurations; selecting a subset of the candidate topologies based on a fitness score that reflects model accuracy, vendor ROI, or delivery efficiency; applying crossover by combining edge connections and node structures from two selected parent topologies to form offspring models; and applying mutation by randomly altering node weights, adding new nodes, or introducing new edges to the offspring models to introduce variation and prevent premature convergence; monitoring, by the request handler, a new request for a product by continuously polling or subscribing to data updates from the at least one electronic device; receiving, by an intention handler executed by the computing system, intention data associated with at least one user, wherein the intention data includes application interaction events, product browsing time, or cart additions; identifying, by the intention handler, an intention of the at least one user by applying a pattern recognition algorithm including: extracting temporal and frequency-based features from the intention data; encoding the features as numerical vectors; comparing the numerical vectors to labeled training data using a classification model; and assigning the intention data to one of a plurality of predefined intent categories including purchase intent, browsing-only intent, or deferred interest intent; determining, by the intention handler, a probability that the at least one user will follow through on the identified intention by accessing historical user activity data and computing a statistical likelihood using a trained decision model; updating the probability in real time based on subsequent intention data collected by the intention handler, including changes in interaction patterns or abandonment signals; transmitting the intention data, including the computed probability, to the NE engine; receiving, by an event handler, real-time event data from a public cloud services processor, wherein the real-time event data includes geolocation-tagged information related to traffic, weather, and public events; transmitting the real-time event data to the NE engine for contextual integration; concurrently receiving, by a processor integrated with the NE engine, the request data, the real-time event data, and the intention data, and generating, by the processor, a predictive evolutionary model for a target market in the mobile retail environment, wherein the NE engine performs neuroevolution by selecting and evolving neural network candidates that maximize a fitness function based on historical sales performance, predicted demand, and mobility constraints; generating, by an AI agent processor in communication with the NE engine, a recommendation model for a first mobile retail vendor based on the predictive evolutionary model, wherein the recommendation model includes vendor-specific delivery timing, product inventory adjustments, and customer engagement strategies; recommending, by the AI agent processor, a route plan for the first mobile retail vendor by computing optimized paths using geospatial data, predicted intent conversion, and vendor capacity constraints; and deploying, by a dispatch processor, the first mobile retail vendor to one or more locations based on the route plan, wherein the dispatch processor transmits executable routing instructions to a vehicle control interface or vendor-facing application.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system to generate a NE model for a target market in a dynamic market place in accordance with some embodiments.

FIG. 2 is a block diagram of a genotype-to-phenotype mapping example configured to implement NE in the processing system of FIG. 1 by using genetic algorithms to perform complex reinforcement learning tasks in accordance with some embodiments.

FIG. 3 is a block diagram of two primary types of structural mutation configured to implement NE in processing system by adding a connection and adding a node in accordance with some embodiments.

FIG. 4 is a block diagram of an example process of aligning genomes with different network topologies using innovation numbers to implement NE in the processing system of FIG. 1 in accordance with some embodiments.

FIG. 5A is an illustration of a device showing an example operational sequence that may be performed when implementing NE in the processing system of FIG. 1 in accordance with some embodiments.

FIG. 5B is an illustration of a device showing an example operational sequence that may be performed when implementing NE in the processing system of FIG. 1 in accordance with some embodiments.

FIG. 5C is an illustration of a device showing an example operational sequence that may be performed when implementing NE in the processing system of FIG. 1 in accordance with some embodiments.

FIG. 6 is a flow diagram illustrating a method for implementing NE in the processing system of FIG. 1 for processing the translation of customer intentions into actionable steps for vendors in accordance with some embodiments.

FIG. 7 is a flow diagram illustrating a method for implementing NE in the processing system of FIG. 1 where the evolutionary process continually updates AI agents for vendors based on real-time inputs in accordance with some embodiments.

FIG. 8 is a flow diagram illustrating a method for implementing NE in the processing system of FIG. 1 where the system incorporates real-time public cloud data to assess potential traffic events and their impact on the predetermined target locations and timings in accordance with some embodiments.

FIG. 9 is a block diagram illustrating a method for implementing NE in the processing system of FIG. 1 where the Evolutionary Process inputs implement the generation of a new AI agent for each mobile vendor in accordance with some embodiments.

FIG. 10 is a block diagram illustrating a training model process for implementing NE in the processing system of FIG. 1 in accordance with some embodiments.

FIG. 11 is a block diagram of an example process of one or more electronic devices of FIG. 1 communicating within an environment through various networks and communication protocols with integration of computer systems for data storage and analysis in accordance with some embodiments.

FIG. 12A is a flowchart illustrating a first portion of a computer-implemented method for optimizing deployment of a mobile retail vendor using a neuroevolution engine that evolves neural network topologies in response to product request data in accordance with some embodiments.

FIG. 12B is a continuation of the method shown in FIG. 12A and illustrates further steps for identifying and classifying user intention using a pattern recognition algorithm, and for calculating and updating a probability of user follow-through behavior in accordance with some embodiments.

FIG. 12C is a continuation of the method shown in FIG. 12A-12B and illustrates how the system transmits behavioral and contextual data to the neuroevolution engine, integrates real-time event data, and uses evolved predictive models to generate and execute a deployment route plan for a mobile retail vendor in accordance with some embodiments.

### DETAILED DESCRIPTION

Conventional processing systems generally employ statistical techniques that attempt to estimate the utility of particular actions in particular states of the world of possible execution models. These systems, often based on traditional reinforcement learning (RL) methods, use value functions to assign numerical values to state-action pairs, representing the expected future rewards of taking a particular action from a given state. Common techniques include Q-learning and SARSA, which are value-based methods that seek to learn optimal action-value functions by updating Q-values based on the difference between predicted and actual rewards. Policy-based methods, such as Policy Gradient techniques, optimize policies directly by adjusting parameters to maximize expected rewards, with approaches like REINFORCE and Actor-Critic being prominent examples. Model-based methods, including Dynamic Programming and Monte Carlo techniques, use known models of the environment to compute optimal policies through iterative improvement of value functions and policies or by averaging returns observed in sample episodes.

Despite their widespread use, conventional statistical techniques face significant limitations, particularly when dealing with high-dimensional and continuous state spaces, as well as non-Markovian tasks. High-dimensional spaces require extensive sampling or discretization, which can be computationally expensive and inefficient. Approximating value functions in complex environments often introduces instability and divergence issues, posing further challenges. Moreover, traditional RL assumes the Markov property, where future states depend only on the current state and action, making it ill-suited for non-Markovian tasks that require consideration of historical information. However, neuroevolution (NE) is employed to evolve one or more neural networks (NN or network) to optimize behaviors rather than value functions. This approach circumvents some of the limitations of conventional RL methods by focusing on behavior search, discovering effective behaviors through evolutionary algorithms that optimize neural network architectures and weights for desirable outcomes. NE is particularly adept at handling continuous and high-dimensional state spaces, as neural networks can represent complex functions mapping states to actions without the need for discretization. This system distinguishes between two main marketplace concepts: pull-based and push-based. In a pull-based marketplace, consumers actively seek out and purchase products, either digitally or physically, from static locations or warehouses. For example, when needing a cab, one calls a cab company or sets an alert for product availability, but ultimately, the consumer must initiate the action. In contrast, a push-based marketplace brings products directly to consumers without requiring them to seek them out. These products notify consumers of their availability in the area, creating a dynamic and real-time market based on the consumer's location, with no guarantee of specific merchandise at any given time.

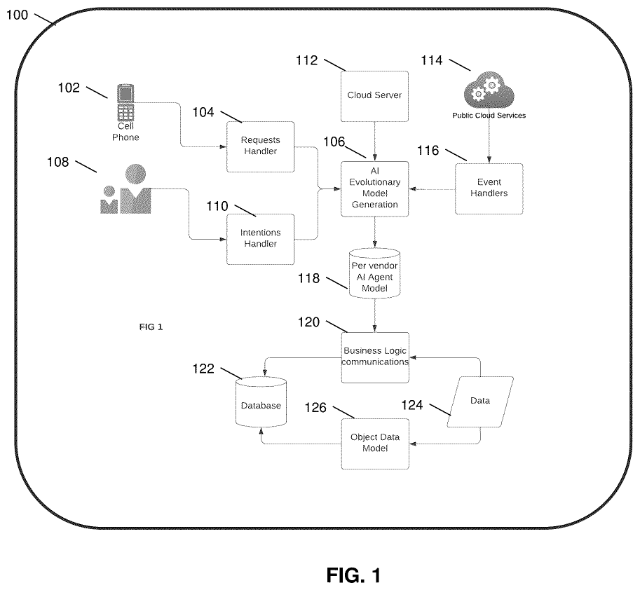

FIGS. 1-12C illustrate example techniques and processes to implement NE, the artificial evolution of neural networks, using one or more genetic algorithms to employ complex reinforcement learning tasks in a processing system. A NE engine searches through the space of possible execution models for a current vendor and various market inputs to solve for an ideal set of execution models that provide routes and locations for a vendor to subsequently visit. Furthermore, recurrent neural networks (RNNs) evolved through NE can inherently capture temporal dependencies and memory, making NE suitable for non-Markovian tasks where historical information influences decision-making. Therefore, the integration of a NE engine within complex systems modeling and monitoring using Machine Learning (ML) models requires evolving the NN and maintaining consistency without losing the evolutionary progress within the network's topology. As a result, this evolution is employed to capture new possible execution models based on current events, inputs, vendor choices, and/or the activities of other vendors. As NE searches for behavior instead of a value function, it is effective in problems with continuous and high-dimensional state spaces. In addition, memory is easily represented through recurrent connections in neural networks, making NE a natural choice for learning non-Markovian tasks and making sense for use for our problems. The system architecture depicted in FIG. 1 employs NE to generate a model configured for a target market.

In implementations, this system creates a dynamic, mobile-efficient marketplace that allows mobile stores to reach customers and fulfill needs in real-time. The technology maintains a dynamic database to reflect the market's current state, sends notifications to potential customers, manages vendor-customer negotiations, and/or ensures timely delivery of products and services. It also provides vendors with effective planning information, optimizing areas of operation based on mutual satisfaction between consumers and vendors. Typically, some vendors may have low disposable incomes, often used to finance daily expenses and supplies. This system addresses this issue by calculating optimal routes to maximize ROI based on location, routes, and/or delivery times, and/or by aggregating vendors in high-traffic areas. It reduces opportunity costs by prioritizing merchandise based on short-term plans and real-time opportunities, giving vendors a competitive edge. The system also predicts future behavior by associating activities with ‘intent,’ such as opening the application, choosing a future product, or attending events. It considers factors like location, median income, time of day, merchandise type, delivery range, past ROI, consumer behavior, and product prices. An evolutionary ML model predicts the best ROI for vendors by evolving a neural network (NN) for each vendor, continuously optimizing routes in real-time based on new opportunities or intents. This real-time evolution ensures that the vendor's route maximizes ROI by taking into account multiple vendor interactions and their mutual influence within the same or related areas.

FIG. 1 is a block diagram of a processing system 100 to generate a NE model for a target market in a dynamic market place. This approach leverages one or more genetic algorithms to evolve neural networks, optimizing them to adapt to the dynamic nature of the marketplace. By continuously refining the neural network's structure and connection weights, the system can identify the most effective strategies for vendor operations. The integration of recurrent connections enables the model to account for temporal dependencies and memory to accurately capture market trends and consumer behavior. This architecture allows for real-time adjustments and ensures that the generated model remains robust and responsive to changes within the target market. For example, if there is a sudden shift in consumer preferences or market conditions, the model can quickly adapt its predictions and recommendations without needing to retrain from scratch. The electronic device 102 includes, but is not limited to, a display device such as a smartphone, a laptop, a desktop computer, a tablet, a smartwatch, an e-reader, a gaming console, and/or a digital assistant. Each of these devices is equipped with a display device or interface through which users interact with applications, access information, and perform various tasks. The electronic device is connected electrically to a request handler, which manages communication and data exchange between the device and external systems or services. At block 104, a request handler is in communication with a NE engine. For example, a request handler establishes communication with the NE engine. The request handler serves as the initial point for receiving and managing requests from various sources, ensuring they are appropriately directed to the NE engine for further processing.

At block 106, the NE engine is configured to generate a model based on data. For example, the NE engine is configured to generate a predictive model based on incoming data. This model creation process utilizes sophisticated algorithms to analyze and derive insights from the data provided. One prominent algorithm utilized is Genetic Algorithms (GA), which mimics natural selection processes to evolve neural network architectures and parameters over successive generations. GA applies genetic operators such as mutation and crossover to explore and exploit the solution space, aiming to improve model performance based on data-driven feedback. Another key algorithm is Neuroevolution of Augmenting Topologies (NEAT), which dynamically evolves neural network structures by incrementally adding complexity through new nodes and connections. NEAT adapts networks to varying data distributions and complexities, enhancing their capacity to capture intricate patterns and relationships.

Additionally, Recurrent Neural Networks (RNNs) and Long Short-Term Memory (LSTM) networks are pivotal within NE algorithms, designed to handle sequential data with temporal dependencies. These architectures enable the NE engine to process time series data effectively, remembering past inputs and making predictions based on learned patterns. Neuroevolution Strategies (NES) optimize neural network parameters directly through evolutionary principles, adjusting weights and biases to enhance task-specific performance. Cooperative Coevolution (CC) algorithms further augment the NE engine's capabilities by evolving multiple network processors independently and optimizing their interactions for complex problem-solving.

At block 112, the data from a cloud server is input into the NE engine. In an example, this data typically includes a wide array of information relevant to the system's operations, such as historical trends, market conditions, and customer behavior patterns. Data from a cloud server encompasses a wide array of digital information hosted and managed within cloud computing infrastructure. This data includes various types of files, databases, and applications that are stored and processed remotely on servers maintained by cloud service providers. The cloud server stores structured and unstructured data such as text documents, spreadsheets, multimedia files, and application data. This storage capability enables organizations to efficiently manage large volumes of information without the need for extensive local hardware infrastructure. In addition to storage, cloud servers facilitate data processing through computational resources allocated on-demand. This processing capability allows for real-time analysis, computation of complex algorithms, and execution of applications that require significant computational power. The cloud server also supports scalable data storage solutions, where storage capacity can be adjusted dynamically based on fluctuating demands, ensuring flexibility and cost-effectiveness for businesses. Moreover, the cloud server provides security measures to protect stored data, including encryption, access controls, and regular data backups. This ensures data integrity and confidentiality, mitigating risks associated with data breaches or loss. The cloud server also enable remote access to data, facilitating collaboration among geographically dispersed teams and seamless integration with other cloud-based services and applications.

At block 114, data from the public cloud services is electronically communicated to the event handler. For example, this data exchange ensures that real-time information and updates from external sources are seamlessly integrated into the system's decision-making processes. Data sourced from public cloud services encompasses a broad spectrum of information for modern applications and systems. This data includes, but is not limited to, real-time updates on events such as market fluctuations, weather conditions, and/or traffic patterns, providing timely insights into dynamic operational environments. Additionally, analytics and metrics derived from these services offer valuable insights into customer behavior, sales trends, and performance metrics, enabling informed decision-making and strategic planning. Geospatial data further enhances understanding with geographic information systems (GIS) providing spatial insights and demographic trends. API data feeds enable seamless integration with third-party services for functionalities such as payment processing and social media interactions. Cloud-based storage solutions offer scalable options for securely managing and backing up large datasets and files. Machine learning models accessible via cloud platforms provide advanced capabilities in image recognition, natural language processing, and predictive analytics. Moreover, access to financial data including economic indicators and stock market trends supports financial planning and strategic decision-making. Collectively, these diverse data streams from public cloud services empower systems to leverage real-time information, sophisticated analytics, and scalable resources essential for optimizing operational efficiency.

At block 116, the data from the event handler is input into the NE engine. The event handler processes and channels data into the NE engine at block 116. This data, enriched with real-time events and contextual information, enhances the NE engine's ability to adapt and respond dynamically to changing conditions and events in the operational environment. For example, the data includes, but is not limited to, real-time events and updates sourced from various sources such as public cloud services to provide current insights into market conditions, consumer behavior patterns, and/or external environmental factors. For instance, event data could include fluctuations in market demand, changes in competitor strategies, or updates on local events and activities impacting business operations. Additionally, data from the event handler may encompass time-sensitive information like traffic conditions, weather forecasts, or social media trends, which are pivotal for dynamic decision-making and model adjustments. The NE engine utilizes this diverse dataset to iteratively train and optimize predictive models, leveraging algorithms like Genetic Algorithms (GA) and Neuroevolution of Augmenting Topologies (NEAT) to adapt neural network structures and parameters based on incoming events. By integrating and processing such event-driven data, the NE engine enhances its capability to generate responsive and accurate predictive models tailored to evolving market dynamics and operational contexts. This approach underscores the NE engine's role in harnessing real-time data inputs to drive informed decision-making and strategic planning in complex environments.

At block 108, one or more users interact with an intentions handler. For example, within the processing system of a dynamic marketplace focused on planning, coordinating, and controlling the movement and storage of goods, services, and information from origin to consumption, users interact with an intentions handler in several ways. For instance, in supply chain management, logistics managers utilize intentions handlers to input and manage orders, track shipments, and optimize distribution routes based on real-time data on inventory levels, customer demands, and transportation logistics. These interactions enable resource allocation, minimize delivery times, and/or reduce operational costs by leveraging predictive analytics and machine learning algorithms embedded within the intentions handler. In retail operations, merchants and vendors engage with intentions handlers to monitor and respond to consumer demand signals, adjust pricing strategies, and manage inventory levels across multiple sales channels. The handler processes data on sales trends, customer preferences, and market dynamics to generate actionable insights for optimizing product placement, enhancing promotional campaigns, and ensuring timely replenishment of stock. This facilitates agile decision-making and improves customer satisfaction through personalized shopping experiences tailored to individual preferences and purchasing behaviors.

As noted above, many retailers utilize intentions handlers to manage a wide array of tasks aimed at optimizing customer experience, inventory management, and overall business performance. Typically, some functionalities of intentions handlers in retail is to monitor and analyze consumer behavior and market trends. Through interactions with these handlers, retailers gather valuable data on customer preferences, purchasing patterns, and product demand across various channels. This data is configured for generating insights that drive decisions related to product assortment planning, pricing strategies, and promotional activities. For example, by analyzing sales data and customer feedback processed by intentions handlers, retailers can identify popular products, adjust inventory levels accordingly, and launch targeted marketing campaigns to maximize sales opportunities. The intentions handler facilitates real-time inventory management and supply chain optimization in retail settings. Retailers can use these handlers to track stock levels, manage order fulfillment processes, and coordinate logistics operations efficiently. By integrating data from suppliers, warehouses, and sales points, intentions handlers enable retailers to streamline supply chain workflows, reduce lead times, and minimize out-of-stock situations, thereby enhancing operational agility and customer satisfaction. Furthermore, intentions handlers support personalized customer engagement strategies in retail. Retailers can leverage these handlers to gather and analyze customer data from multiple touchpoints, including online platforms, mobile applications, and in-store interactions. This enables retailers to deliver personalized recommendations, tailored promotions, and seamless shopping experiences that cater to individual preferences and purchasing behaviors. For instance, intentions handlers can analyze browsing history and transaction data to suggest relevant products, offer loyalty rewards, and optimize the placement of products within physical stores to enhance visibility and sales.

At block 110, the intentions handler is in communication with the NE engine. The request handler and the intentions handler data both input data into the NE engine. For example, the request handler interfaces with various data sources such as inventory databases, supply chain logistics, and transportation schedules. For example, it collects real-time data on inventory levels, warehouse capacities, and shipping routes, providing insights into supply chain dynamics and operational bottlenecks. Simultaneously, the intentions handler gathers user preferences, customer orders, and service requests, interpreting these inputs to forecast demand patterns and optimize resource allocation.

These data inputs from the request handler and intentions handler are integrated and processed by the NE engine to generate actionable insights and optimize decision-making processes. For instance, based on aggregated data from the request handler about inventory availability and transportation logistics, combined with customer preferences and service requests gathered by the intentions handler, the NE engine can generate predictive models for inventory management, route optimization, and customer delivery preferences. This enables efficient resource allocation, minimizes lead times, and enhances overall supply chain agility.

Moreover, in sectors such as retail and e-commerce, the request handler may gather data on product availability, sales trends, and vendor performance, while the intentions handler collects customer feedback, purchase histories, and personalized service requests. This combined data enables the NE engine to predict consumer behavior, optimize product placements, and personalize marketing strategies to enhance customer satisfaction and loyalty. Overall, by leveraging inputs from both the request handler and intentions handler, the NE engine supports strategic planning, operational efficiency, and responsive decision-making in dynamically evolving marketplace environments.

At block 106, the NE engine generates a model based on input data from the cloud server and the event handler. At block 118, the model is generated and outputs an AI agent model for one or more vendors to a business logic communications processor. For example, implementing the generation of a model that outputs an AI agent for vendors to a business logic communications processor involves a structured process within the dynamic marketplace framework. Initially, the NE engine synthesizes data from various sources such as customer interactions, market trends, and operational metrics. This data is processed through machine learning algorithms that analyze patterns and predict outcomes relevant to vendor operations. Once the model is generated, it produces an AI agent that encapsulates optimized decision-making capabilities tailored to vendor-specific contexts. This AI agent is designed to interpret real-time data inputs and execute decisions autonomously within the marketplace environment. For example, it may adjust pricing dynamically based on demand fluctuations, optimize inventory levels to minimize stockouts, or recommend promotional strategies to maximize sales. The AI agent model is then transmitted to a business logic communications processor, which acts as a central hub for distributing operational instructions and receiving feedback from vendors. This processor facilitates communication between the AI agent and other components of the marketplace ecosystem, including supply chain management systems, customer relationship management tools, and/or marketing platforms. Feedback loops enable the NE engine to update the model based on real-world performance data, ensuring its relevance and effectiveness in meeting business objectives. At block 120, detailed data from each vendor's AI agent model is transmitted to a business logic communications processor. For instance, a mobile food truck's AI agent might send information about current inventory levels, popular menu items, real-time sales data, and location updates. This data enables the processor to manage and optimize business operations, such as restocking ingredients, updating the menu based on customer preferences, and coordinating logistics for food truck deployment to high-demand areas.

At block 124, data is input into the business logic communications processor. At block 122, data from the business logic communications processor is input into the database. For example, initially, relevant data sources such as customer transactions, inventory levels, and market trends are aggregated and processed to ensure accuracy and completeness. This data typically includes real-time information from various internal systems and external sources, ensuring that the processor has a comprehensive view of current market conditions and business operations. Once collected, the data is formatted and transmitted to the business logic communications processor, which serves as a central repository and processing hub. This processor integrates incoming data streams, applying predefined business rules and algorithms to extract actionable insights and generate operational directives. For instance, it may receive updates on inventory levels from supply chain systems, customer feedback from CRM platforms, or market analytics from external data providers. The business logic communications processor then disseminates processed data to relevant stakeholders and operational units across the marketplace ecosystem. This includes transmitting instructions to AI agents, updating inventory management systems with real-time sales data, or triggering automated responses based on predefined thresholds or conditions.

At block 124 data is also processed to generate an object data model. At block 126, the object data model is input to the database. For example, raw data collected from various sources such as customer interactions, transaction records, and operational metrics undergoes preprocessing and transformation. This phase includes data cleaning, normalization, and integration to ensure consistency and relevance across different datasets. Once prepared, the data is processed using algorithms and methodologies specific to object-oriented modeling. This involves structuring the data into cohesive objects that represent entities within the marketplace ecosystem, such as customers, products, orders, and transactions. Attributes and relationships are defined within these objects to capture key business insights and enable complex querying and analysis. The object data model, once generated, serves as a comprehensive representation of the marketplace's operational entities and their interdependencies. At this stage, the model encapsulates structured data that supports various business functions, including inventory management, customer relationship management, and sales forecasting. It provides a unified view of business operations, facilitating efficient data retrieval and manipulation for decision-making purposes. Subsequently, the object data model is input into the database infrastructure. This involves storing the structured data in a relational or non-relational database management system (DBMS), depending on the specific requirements of the marketplace. The database ensures persistent storage and efficient retrieval of the object data model, supporting ongoing operations and analytics initiatives.

As noted above, the system architecture of processing system 100 generates a model tailored for a target market using a machine learning engine driven by NE. The process begins with the collection of extensive data on market dynamics, consumer behavior, and vendor interactions. This data serves as the input for the machine learning engine, which employs NE to evolve neural networks capable of accurately modeling the target market. In the NE process, genetic algorithms are used to simulate the principles of natural selection. Initially, a diverse population of neural network architectures is created, each representing a potential solution. These networks undergo a series of evaluations based on their performance in predicting market trends and optimizing vendor strategies. Key performance metrics, such as prediction accuracy and ROI, are used to assess each network's effectiveness. The networks with the best performance are selected to form the basis for the next generation. Genetic operations, including crossover and mutation, are applied to these selected networks to introduce variations and create new network architectures. Crossover combines features from two parent networks to produce offspring networks, while mutation introduces random changes to the network's structure or connection weights. This evolutionary process is iterated over many generations, with each iteration refining the networks to better fit the target market. Recurrent connections within the neural networks allow them to maintain a memory of past interactions, enabling the model to capture temporal dependencies and make informed predictions based on historical data. This feature is particularly important for handling non-Markovian tasks, where the current state depends on a sequence of previous states.

As noted above, as the neural networks evolve, the system continuously monitors their performance, ensuring that the model remains robust and adapts to any changes in the market environment. By integrating these advanced machine learning techniques with NE, the system architecture effectively constructs a highly accurate and responsive model tailored to the specific needs and dynamics of the target market. This system is designed around an AI model that handles interactions, intentions, and demands as they occur in real-time from multiple sources, which will be discussed later. As previously described, intents can be one of the following: a user opening the application, a user selecting a future product, or a user spending time on a specific product within the application. User behavior, as illustrated by the list above, results in an intent event within the system. An intent can also be a deliberate choice made by the user to inform the system of their intentions.

In as example, for every intent, the system calculates a probability associated with a specific user, representing the likelihood that the user will act on their intention. This probability is determined based on various factors, such as the nature of the intent, the time it was established, and the user's follow-through behavior. Probabilities are calculated for all users and their intents. Additionally, the system tracks new requests for each product daily, both of which influence the system's suggestions and decision-making processes. By analyzing these probabilities, the system identifies optimal opportunities for vendors to maximize their profitability while considering variables such as trip time, fuel costs, and other related overhead expenses. The core problem addressed by this system is determining the optimal time and location for a mobile vendor to be present to maximize ROI throughout a working day. To achieve this, an AI agent representing the vendor is trained using an evolutionary model. This model evaluates combined events related to the vendor and other vendors within the same operational field. The system also integrates public cloud-based events, including traffic conditions, transit times, and public events such as sports games and music concerts in various operational zones.

The processing system 100 comprises a central processing unit (CPU) and a parallel processing unit (PPU), also referred to as a parallel processor. In various embodiments, the CPU includes one or more single-or multi-core processors. The parallel processor may consist of any combination of hardware and/or software that collaboratively performs functions and computations, accelerating tasks related to graphics processing, data parallel tasks, and nested data parallel tasks. This acceleration is achieved more efficiently compared to conventional CPUs, graphics processing units (GPUs), or combinations thereof.

In the embodiment depicted in FIG. 1, the processing system 100 is integrated onto a single silicon die or package, combining the CPU and the parallel processor to create a unified programming and execution environment. This environment allows the parallel processor to be utilized as seamlessly as the CPU for certain programming tasks. In other embodiments, the CPU and the parallel processor are formed separately and mounted on the same or different substrates. It should be noted that the processing system 100 may include additional or different software, hardware, and firmware components beyond those illustrated in FIG. 1. For instance, the system may feature one or more input interfaces, non-volatile storage, output interfaces, network interfaces, and displays or display interfaces. Examples of the processing system 100 include servers, desktop computers, laptop computers, tablet computers, mobile phones, gaming consoles, and similar devices.

In implementations, the processing system 100 is equipped with essential components including system memory, an operating system, a communications infrastructure, and various applications. System memory access is governed by a memory controller (not depicted), which interfaces directly with the system memory to manage read and write requests from the CPU and other connected devices. The applications within the system encompass a range of programs and commands designed to execute computations, which are processed both by the CPU and selectively delegated to the parallel processor for enhanced performance. The operating system and communications infrastructure play pivotal roles within the processing system, facilitating the management of resources and enabling seamless interaction between different components and external networks. Additionally, integral components of the processing system 100 include a device driver and a memory management unit, such as an input/output memory management unit (IOMMU), which further optimize data handling and resource allocation. These components of the processing system 100 are implemented using a combination of hardware, firmware, and software, tailored to meet specific operational requirements. It is noteworthy that the processing system 100 may encompass additional or alternative software, hardware, and firmware components beyond those explicitly illustrated in FIG. 1, depending on the system's configuration and intended functionalities.

Within the processing system 100, the system memory encompasses non-persistent memory components like DRAM (not explicitly shown). Across different implementations, system memory serves as a repository for various types of data and instructions for system operation. This includes processing logic instructions, constant values, variable values used during application execution, and other essential information. For instance, segments of control logic necessary for executing operations on the CPU are temporarily stored in system memory during their respective execution phases. Similarly, applications, functions of the operating system, processing logic commands, and system software reside within the system memory during their operational cycles. Fundamental control logic commands essential for the operating system also find residence in the system memory during their execution. Moreover, in some configurations, additional software commands such as device drivers may also be housed in the system memory while the processing system 100 is active.

In various embodiments, the communications infrastructure interconnects the components of processing system 100. Communications infrastructure includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some embodiments, communications infrastructure also includes an Ethernet network or any other suitable physical communications infrastructure that satisfies an application's data transfer rate requirements. Communications infrastructure also includes the functionality to interconnect components, including components of processing system 100. A driver, such as device driver, communicates with a device (e.g., parallel processor) through an interconnect or the communications infrastructure. When a calling program invokes a routine in the device driver, the device driver issues commands to the device. Once the device sends data back to the device driver, the device driver invokes routines in an original calling program. In general, device drivers are hardware-dependent and operating-system-specific to provide interrupt handling required for any necessary asynchronous time-dependent hardware interface. In some embodiments, a compiler is embedded within device driver. The compiler compiles source code into program instructions as needed for execution by the processing system 100. During such compilation, the compiler applies NE algorithms to program instructions at various phases of compilation. In other embodiments, the compiler is a stand-alone application. In various embodiments, the device driver controls operation of the parallel processor by, for example, providing an application programming interface (API) to software (e.g., applications) executing at the CPU to access various functionality of the parallel processor.

In various implementations, the communications infrastructure serves to interconnect the components within the processing system 100. This infrastructure, which may include components like a Peripheral Component Interconnect (PCI) bus, Extended PCI Express (PCI-E) bus, Advanced Microcontroller Bus Architecture (AMBA) bus, Advanced Graphics Port (AGP), or other similar communication channels, facilitates seamless interconnection between various system elements. Additionally, the communications infrastructure encompasses physical networks such as Ethernet or other suitable mediums capable of meeting the data transfer rate requirements of specific applications. Moreover, the communications infrastructure provides the necessary functionality to interconnect all components within the processing system 100, ensuring efficient communication between them. A driver, such as a device driver, plays a role in facilitating communication between devices (e.g., the parallel processor) and the system via the interconnect or communications infrastructure. When a program calls upon a routine within the device driver, the driver issues commands to the device. Upon receiving data from the device, the device driver invokes routines within the original calling program. Device drivers are typically tailored to specific hardware and operating systems, providing essential interrupt handling for synchronous and asynchronous hardware interfaces. In certain configurations, a compiler integrated within the device driver compiles source code into executable program instructions required by the processing system 100. During compilation, this compiler may apply NE algorithms at various stages to optimize program instructions. Alternatively, in other setups, the compiler operates independently as a standalone application. Furthermore, the device driver manages the operation of the parallel processor by offering an Application Programming Interface (API) that allows software applications executing on the CPU to access and utilize various functionalities provided by the parallel processor.

The CPU within the processing system 100 incorporates components such as a control processor, field programmable gate array (FPGA), application specific integrated circuit (ASIC), or digital signal processor (DSP), though these are not explicitly shown. It manages and executes a portion of the control logic responsible for governing the operations of the system. For instance, in various configurations, the CPU handles the execution of the operating system, one or more applications, and device drivers. Moreover, the CPU initiates and oversees the execution of applications by distributing processing tasks across both the CPU itself and other processing resources, including the parallel processor. The parallel processor, on the other hand, specializes in executing commands and programs tailored for parallel processing tasks, particularly those related to graphics operations and other computationally intensive operations. It operates by executing a single instruction across multiple data or threads simultaneously. Examples of parallel processors encompass graphics processing units (GPUs), massively parallel processors, processors utilizing single instruction multiple data (SIMD) architecture, and single instruction multiple thread (SIMT) architecture processors, each adept at performing tasks in fields such as graphics rendering, machine learning algorithms, and computational operations.

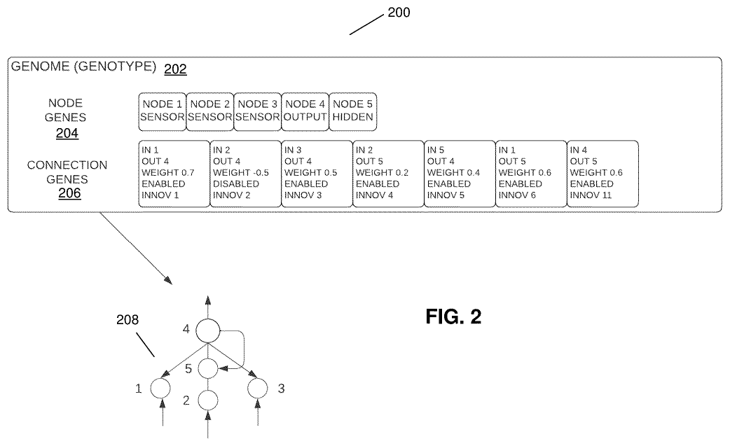

In various implementations, parallel processors may either exist as separate devices integrated within a computer system or as advanced processor units combined within a single device alongside a host processor like a central processing unit (CPU). Typically, parallel processors are employed extensively for executing machine learning algorithms and rendering graphical content for display purposes. Additionally, in some configurations, parallel processors handle compute processing tasks unrelated to graphics, such as video operations, physics simulations, and computational fluid dynamics, executing commands received from the CPU via specialized processors like dispatch processors or command processors. By employing genetic algorithms as shown in FIG. 2, NE iteratively modifies the genotypes through processes akin to natural selection, mutation, and crossover. This iterative process refines the neural networks, optimizing their performance on reinforcement learning tasks by evolving their topologies and connection weights.

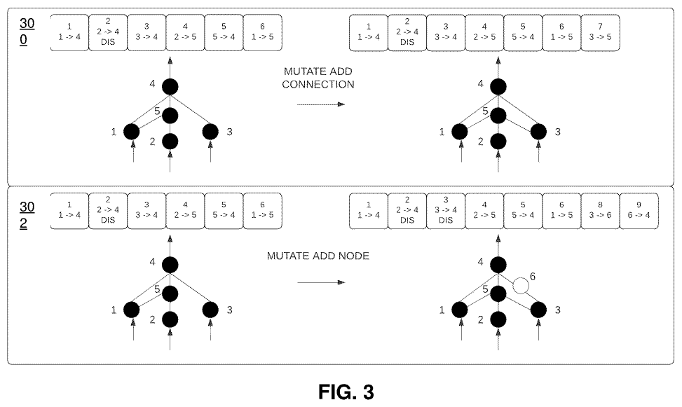

FIG. 2 is a block diagram of a genotype-to-phenotype mapping example 200 configured to implement NE in a processing system by using genetic algorithms to perform complex reinforcement learning tasks. It details the genotype-to-phenotype mapping process, which is a fundamental aspect of NE. In this context, the genotype 202 represents the encoded structure of a neural network, which is then decoded into the phenotype, the actual neural network that will be used for learning and decision-making. For example, Node genes 204 may include, but not be limited to, node 1 sensor, node 2 sensor, node 3 sensor, node 4 output, and node 5 hidden. Connection genes 206 may include, but not be limited to, in 1, out 4, weight 0.7, enabled, innovation 1; input 2, output 4, weight 0.5, disabled, innovation 2; input 3, output 4, weight 0.5, enabled, innovation 3; input 2, output 5, weight 0.2, enabled, innovation 4; input 5, output 4, weight 0.4, enabled, innovation 5; input 1, output 5, weight 0.6, enabled, innovation 6; and input 4, output 5, weight 0.6, enabled, innovation 11. The output phenotype 208 shows an input at input node 1, input node 2, input node 3 with output node 4 configured to output a feedback loop at hidden node 5 as well as 4 outputting data to node 1 and node 3. In implementations, genotype 202 produces a phenotype with three input nodes, one hidden node, one output node, and seven connection definitions, including one recurrent connection. The mapping process allows certain genes to be disabled; for instance, in the given example, the second gene is disabled, meaning the connection it specifies (between nodes 2 and 4) does not appear in the resulting phenotype. This selective expression of genes enables the flexible and dynamic evolution of neural network structures, allowing the system to explore a wide range of network configurations and identify those best suited for the given tasks. In various implementations, structural mutations may implement NE in the processing system to generate variations of a genome as illustrated in FIG. 3.

FIG. 3 illustrates the two primary types of structural mutation configured to implement NE in the processing system by, at block 300, adding a connection between node 5 and node 3 and at block 302, adding a node 6 between node 4 and node 3. In these examples, the connection genes of a network are shown above their corresponding phenotypes, with each gene assigned a unique innovation number. These innovation numbers serve as historical markers, identifying the original ancestor of each gene. When new genes are introduced, they are assigned incrementally higher innovation numbers. In the process of adding a connection, a single new connection gene is appended to the end of the genome and assigned the next available innovation number. In contrast, when adding a new node, the connection gene being split is disabled, and two new connection genes are appended to the genome. The new node is inserted between these two new connections, and a new node gene representing this addition is also included in the genome.

In implementations, the genetic encoding scheme facilitates the alignment of corresponding genes during crossover events in mating. Genomes, which are linear representations of network connectivity, include a list of connection genes, each referring to two node genes that are connected. Node genes enumerate the inputs, hidden nodes, and outputs available for connection. Each connection gene specifies the input node, output node, connection weight, an enable bit indicating whether the connection is expressed, and an innovation number that helps identify corresponding genes. Mutation can alter both connection weights and network structures. Connection weights mutate in the NE system, with each connection either perturbed or unchanged in each generation. Structural mutations may occur in two ways, expanding the genome size by adding new genes. In the add-connection mutation, a single new connection gene with a random weight is added, connecting two previously unconnected nodes. In the add-node mutation, an existing connection is split, and a new node is introduced at the split. The old connection is disabled, and two new connections are added, with the new connection leading into the new node assigned a weight of 1, and the new connection leading out assigned the same weight as the old connection. This method minimizes the initial impact of the mutation, allowing the new node to be integrated smoothly into the network without the need for extensive evolution.

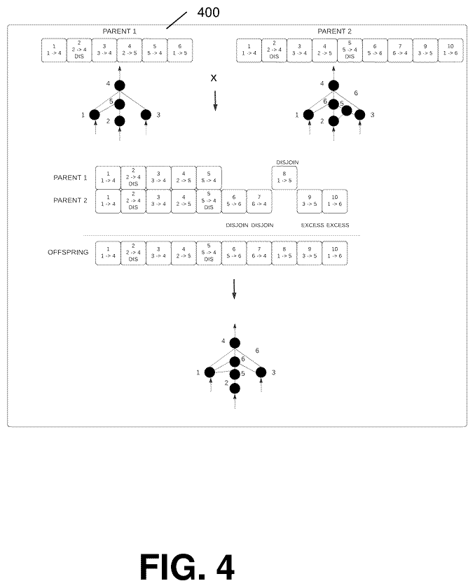

This genetic encoding scheme allows the system to track the historical origins of each gene, ensuring that genes with the same innovation number represent the same structural elements, albeit possibly with different weights. This historical tracking is configured for maintaining consistency during crossover and for understanding the evolutionary lineage of each gene. Whenever a new gene appears through structural mutation, a global innovation number is incremented and assigned to the gene, creating a chronological record of every gene's appearance in the system. This method ensures that the system can accurately align corresponding genes between individuals in a diverse population, facilitating the evolutionary process. Genomes with different network topologies can be aligned using innovation numbers, allowing the creation of new structures by combining overlapping and unique genes from both parents, with inheritance determined by gene type and parent fitness, as shown in FIG. 4.

FIG. 4 illustrates an example process 400 of aligning one or more genomes with different network topologies using innovation numbers to implement NE in the processing system of FIG. 1. Despite their differences, the innovation numbers (displayed at the top of each gene) indicate how the genes correspond between Parent 1 and Parent 2. Without any topological analysis, a new structure can be generated by combining the overlapping genes from both parents as well as their unique genes. Matching genes are inherited randomly, while disjoint genes (those not aligning in the middle) and excess genes (those not aligning at the ends) are inherited from the fitter parent. In cases of equal fitness, disjoint and excess genes are inherited randomly. Disabled genes may become enabled in future generations, as there is a preset chance for an inherited gene to be disabled if it is disabled in either parent.

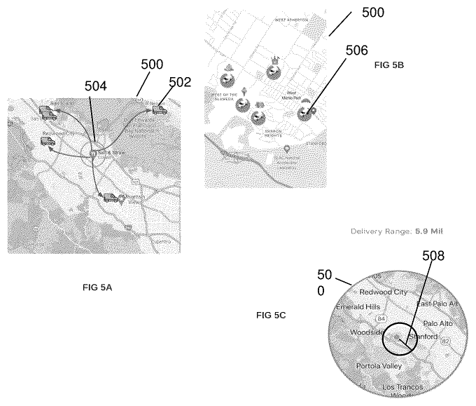

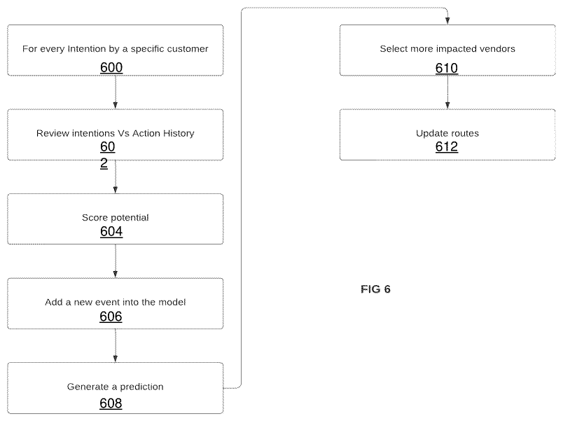

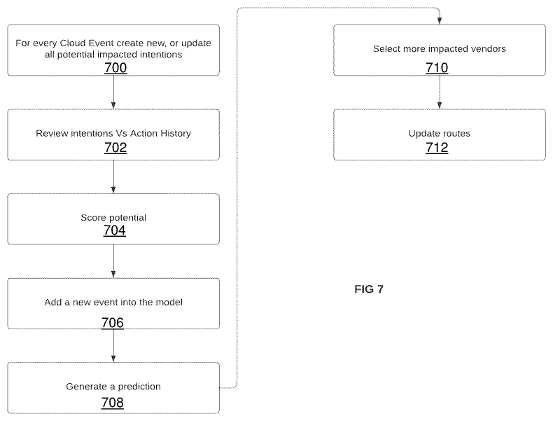

The system may create a population with diverse topologies by introducing new genes and intelligently mating genomes representing different structures. Further, this system offers a solution to various technical challenges in the logistics management of mobile grocery stores by employing ML models that account for the uncertainties and variabilities of the parameters involved. Additionally, it addresses the need for greater consideration of dynamic aspects in existing literature on supply chain networks, which is seen as the current known art, by incorporating the time-varying nature of the problem. As noted above, the system utilizes the neuro-evolution model, where each genome is evaluated as part of the training process to develop a real-time ML model. This model considers the uncertainties and variabilities of the parameters while also addressing the dynamic aspects of the inputs. In an example, to make a decision, the system must determine the next location for this specific vendor. Each AI agent selected in the AI evolutionary model represents a vendor, specifically a mobile vendor, allowing the system to avoid using actual trucks or vendors in a physical location. Instead, AI agents are employed to identify optimal vendor locations based on the provided information. Multiple agents are enabled to make decisions, with the most profitable or accurate AI agent ultimately directing the truck or vendor. The relationship between the current vendor location and the potential of moving to a related area is described in FIGS. 5A-5C.

FIG. 5A is an illustration of a device 500 showing an example operational sequence that may be performed when implementing NE in the processing system of FIG. 1. Here, multiple competing locations, such as at competing location 502, that a vendor located at vendor location 504, for example, might consider moving to, each differing by potential ROI. To make an informed decision, the system must consider not only the potential ROI of each location but also the expenses associated with traveling to these locations. This includes the immediate trip costs and the potential expenses related to subsequent locations throughout the day. The system uses AI agents to evaluate these factors, ensuring that each decision maximizes profitability while minimizing costs. This dynamic decision-making process allows the vendor to adapt to changing conditions and optimize their route for the highest overall return on investment. The system optimizes a vendor's route by considering the proximity and potential business synergies with other vendors to maximize overall ROI, as shown in FIG. 5B.

FIG. 5B is an illustration of the device 500 showing an example operational sequence that may be performed when implementing NE in the processing system of FIG. 1 in accordance with some embodiments. Here, the relationship between multiple vendors, such as vendor 506, operating in close proximity, such as 5.9 miles, is analyzed by the system. When recommending or identifying the next location in a vendor's trip plan, the system must consider the presence of other vendors in the same potential area and time frame. The system optimizes the trip to maximize ROI by analyzing how the proximity of other vendors and their goods might impact overall business. If the vendors and their products are related in a way that can enhance mutual business opportunities, the system will recommend locations that provide such synergistic benefits. This approach ensures that the vendors are strategically positioned to capitalize on increased customer traffic and related sales, thereby improving the overall profitability for all vendors involved. In some implementations, vendors may select their delivery range, influencing a tailored ML recommendation model, alongside considerations of daily merchandise choices, expiration dates, and other relevant parameters as described in FIG. 5C.

FIG. 5C is an illustration of the device 500 showing an example operational sequence that may be performed when implementing NE in the processing system of FIG. 1 in accordance with some embodiments. A process for vendors to choose a delivery range 508 is described. The system provides each vendor with the option to select the delivery range 508, which then influences the machine learning (ML) recommendation model tailored for that vendor. This aspect ensures that the vendor's preferences and operational constraints are considered in the decision-making process. Additionally, the system takes into account other inputs such as the vendor's daily selection of merchandise, the expiration dates of perishable items, and various other parameters. By integrating these factors, the system can generate optimized recommendations that align with the vendor's specific needs and enhance overall efficiency and profitability. There is also a recommendation by the system to each vendor and to all vendors, in general, a prioritized list of potential merchandise and ideal location a week, a day, and an hour ahead of time. The vendor chooses what to pick up and needs to report this to the system. The system takes this input as an event and recalculates the ideal route for this vendor. An example of how customer intentions are evaluated based on historical behavior, timing, urgency, and local context using an ML model to predict their impact on vendor routes is described in FIG. 6.

FIG. 6 is a flow diagram illustrating a method for implementing NE in the processing system of FIG. 1 for processing the translation of customer intentions into actionable steps for vendors. At block 600 of the system's operational flow, each time a specific customer expresses an intention, the system initiates an assessment routine. This routine serves to evaluate the nature and context of the intention within the broader framework of the customer's history and preferences. For instance, if a customer indicates interest in purchasing a product or service, this triggers the assessment process to begin. Moving to block 602, the system examines the customer's stated intentions against their historical actions. This step involves a detailed comparison to determine the consistency and reliability of the customer's intentions based on past behavior. For example, if a customer frequently expresses interest in certain products but rarely completes purchases, this discrepancy would be noted and factored into subsequent assessments. Upon completion of the assessment at block 604, the system generates a potential score. This score reflects the likelihood or probability that the customer's current intention will translate into a concrete action, such as a purchase or a specific interaction. This predictive score facilitates the guiding of the system's decision-making process for the next steps. Moving forward to block 606, the system integrates the outcome of the assessment as a new event into its predictive model. This event, which encapsulates the assessed intention and its associated score, enriches the system's understanding and improves its future predictive accuracy.

At block 608, leveraging the assessed data and predictive scores, the system generates a prediction. This prediction forecasts the most probable outcome or action that the customer is likely to take based on their expressed intentions and historical behavior patterns. For instance, the system might predict that the customer is highly likely to purchase a specific product based on their recent browsing history and past purchase patterns. Following this prediction, at block 610, the system may select vendors or stakeholders who are potentially impacted by the customer's anticipated action. This step ensures that relevant parties are informed or prepared based on the system's predictive insights, enabling proactive engagement or preparation. Continuing to block 612, the system is configured to update one or more routes or workflows based on the predicted outcomes and identified stakeholders. This adjustment ensures that subsequent interactions or operations are aligned with the anticipated actions of the customer, optimizing efficiency and enhancing customer satisfaction. This structured operational flow illustrates how the system systematically assesses, predicts, and adjusts its operations based on customer intentions and historical behavior, ultimately enhancing predictive accuracy and operational efficiency.

In implementations when a new customer's intention is recorded, it undergoes assessment to determine its significance, factoring in variables such as the customer's historical behavior concerning similar intentions, the timing, urgency, local context, and other relevant factors. These inputs collectively influence the probability or likelihood of the intention culminating in a successful sales transaction. The predictive model at the core of this process utilizes machine learning techniques to generate forecasts. These predictions subsequently trigger events within the system, directly impacting the routes and schedules of vendors. This integrated approach ensures that vendor activities are dynamically aligned with customer intentions, optimizing operational efficiency and enhancing the overall customer experience. FIG. 7 outlines a system where the evolutionary process continually updates AI agents for vendors based on real-time inputs such as changing intentions, merchandise status, external events, and local conditions, directing each vendor to their best sales location accordingly.

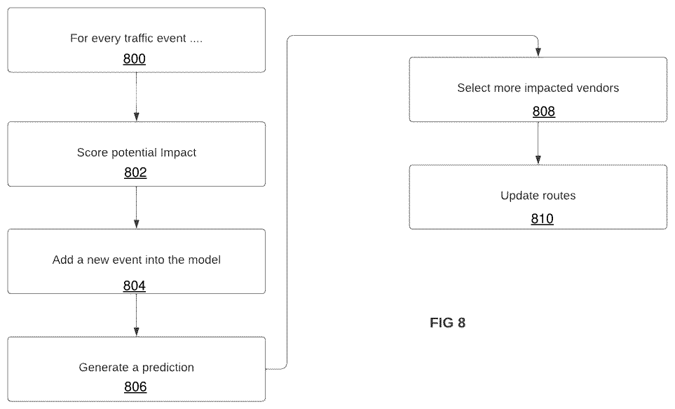

FIG. 7 is a flow diagram illustrating a method for implementing NE in the processing system of FIG. 1 where the evolutionary process continually updates AI agents for vendors based on real-time inputs. At block 700 of the process outlined in the system, one or more cloud events triggers the creation or updating of potential impacted intentions, encompassing changes in vendor plans, merchandise status, or external factors like local events or traffic conditions that could affect vendors'profitability. Moving to block 702, the system reviews the historical data of intentions versus actual actions taken by vendors. Subsequently, at block 704, potential outcomes are scored based on these insights and current conditions. At block 706, the system incorporates each new event into its predictive model, adjusting future predictions accordingly by block 708. At block 710, vendors with the most significant potential impact are selected for further action, and at block 712, their routes are updated to optimize their operations based on the latest data and predictions. A real-time public cloud data is configured to evaluate traffic events affecting planned target locations and timings, adjusting recommendations to maximize ROI. The system dynamically updates mobile vendor schedules based on current conditions and remaps their day if they relocate as described in FIG. 8.

FIG. 8 is a flow diagram illustrating a method for implementing NE in the processing system of FIG. 1 where the system incorporates real-time public cloud data to assess potential traffic events and their impact on the predetermined target locations and timings. At block 800 in the system's process, one or more monitored traffic events undergo a detailed analysis. For example, if there's a major accident reported on a key delivery route, the system immediately assesses its potential impact on vendor routes and delivery schedules. Moving to block 802, the system scores the potential impact of the traffic event based on factors such as the severity of the incident, historical traffic patterns, and alternative route availability. For instance, a severe traffic jam might receive a high impact score due to its potential to delay multiple vendor deliveries. At block 804, the event data is integrated into the system's predictive model. For instance, the accident on a major highway is logged into the model, which now predicts increased travel times for affected vendors. Block 806 involves generating predictions based on the updated model, such as forecasting longer delivery times or suggesting alternative routes to minimize delays. At block 808, vendors with the most significant potential impact from the traffic event are identified. For example, vendors with deliveries scheduled along the affected route are prioritized for route adjustments or alternative scheduling. Finally, at block 810, the system updates routes for these vendors accordingly, rerouting them away from the congested area to maintain delivery efficiency and minimize delays, ensuring timely product deliveries despite unexpected traffic events.

In implementations, events such as traffic delays, can alter the forecasted return on investment (ROI), prompting the system to recommend updated targets that maximize ROI. Consequently, the suggested next target address and time for a mobile vendor may change dynamically based on current conditions. Additionally, if a mobile vendor opts to drive to a different location, the system adjusts accordingly by remapping their entire day's schedule from their current location onward, always aiming to optimize their ROI in light of the new circumstances. The system's high-level execution of the evolutionary process involves responding to new events such as changes in vendor intentions, merchandise expiration dates, or external factors like local events or traffic disruptions, all of which can impact a mobile vendor's ROI. For each vendor, this triggers the development of their AI agent representative through neuro-evolution. This process integrates inputs such as the vendor's current state, goods inventory, ideal location range, current location, and dynamic factors like consumer behavior, local income levels, and time of day. Once the AI agent is trained and ready, it is stored as the vendor's personalized AI agent, guiding them to their optimal next location for selling their goods based on real-time data and predictions.

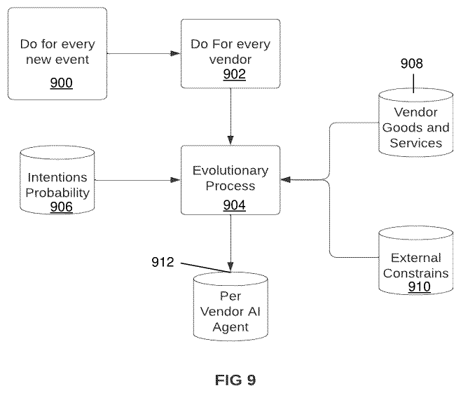

FIG. 9 is a block diagram illustrating a method for implementing NE in the processing system of FIG. 1 where the Evolutionary Process inputs implement the generation of a new AI agent for each mobile vendor. At block 900 of the process depicted in the system, every new event triggers updates across the board. For instance, if a local festival is announced, prompting an influx of potential customers, the system must adjust its strategies accordingly. Moving to block 902, the system adapts its operations for each vendor based on the event's impact. For example, vendors specializing in event-related merchandise may see increased demand. At block 904, an evolutionary process generates a tailored AI agent for each vendor, taking into account various critical factors. At block 906, the system incorporates probabilities of vendor intentions into the evolutionary process initiated at block 904. For example, if a vendor plans to focus on promoting seasonal items during a holiday, this intention affects the AI agent's decision-making process.

At block 908, details about the goods and services available from each vendor are fed into the evolutionary process initiated at block 904. For instance, a vendor specializing in perishable goods must update their offerings in real-time to reflect current inventory levels and expiration dates. At block 910, external constraints such as weather conditions or local regulations are integrated into the evolutionary process started at block 904. For example, a sudden snowstorm may prompt vendors to adjust their delivery schedules and routes to ensure timely service despite adverse weather conditions. At block 912, the output of the evolutionary process for each vendor's AI agent is analyzed and utilized. For example, in the case of a mobile food truck, the evolutionary process might involve the AI agent learning from past sales data, customer feedback, and seasonal trends. The output could include optimized menu recommendations, pricing strategies, and location suggestions to maximize profits. This process ensures that each mobile food truck continuously improves its operations by adapting to changing market conditions and customer preferences.

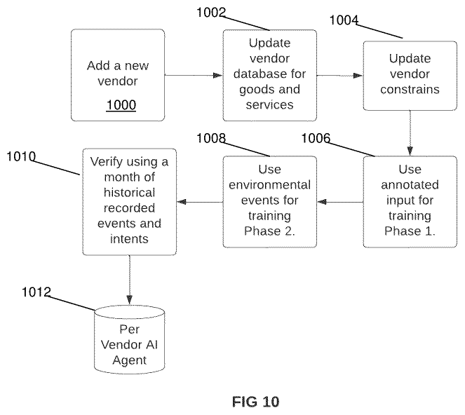

As noted above, when events enter the system, triggering updates, one or more agents, each representing a vendor, are evolved to adapt to the changing circumstances. Real-time data on the goods and services currently available from each mobile vendor is retrieved from a database, which continuously updates with minute-by-minute measurements. This database includes information on the types of goods, their availability durations, and other relevant details defining each product or service. Intentions, such as vendor plans and customer preferences, along with their associated probabilities, are integral training inputs for the AI agents. Any changes in these intentions prompt updates to the training data, ensuring the agents remain accurate and responsive to evolving conditions and consumer behavior. FIG. 10 outlines a training and deployment model where new mobile vendors are integrated into a database, trained with annotated data to maximize ROI, refined with environmental events for market navigation, tested against historical records, and deployed as agents guiding real-time operations.

FIG. 10 is a block diagram illustrating an example training model process for implementing NE in the processing system of FIG. 1. At block 1000, when a new mobile food truck vendor, such as a gourmet burger truck, joins the food truck marketplace platform, the system begins by integrating their business into its operations. This involves gathering comprehensive information about the truck's menu offerings, including items like specialty burgers, sides, and beverages. Moving to block 1002, the vendor database is updated to reflect the gourmet burger truck's menu and services, to name a few examples. This update ensures that the system accurately categorizes and displays available items on the platform, making it easier for customers to browse and place orders. At block 1004, the system updates vendor constraints based on the food truck's operational needs and regulations. Constraints may include factors such as operating hours, location restrictions for parking, menu pricing adjustments based on ingredient availability and seasonal offerings like adding special holiday-themed burgers or summer drinks.

Transitioning to block 1006, annotated input data is used during the first training phase to refine the system's understanding of customer preferences and market trends. Historical sales data, customer reviews, and feedback are analyzed to identify popular menu items, preferred burger combinations, and peak times for sales. This helps the system recommend optimal pricing strategies and menu adjustments to maximize customer satisfaction and sales. Moving to block 1008, environmental events are simulated during the second training phase to enhance the food truck's adaptability. Scenarios might include sudden changes in weather affecting outdoor dining preferences, local events or festivals influencing foot traffic, or competitor food trucks launching new menu items. By training the AI models with these scenarios, the system learns to make proactive decisions such as adjusting menu offerings, changing locations, or optimizing promotional activities. At block 1010, the system verifies the trained models using a month of historical recorded events and customer intents. This validation ensures that the AI accurately predicts customer demand fluctuations, sales patterns during different times of the day or week, and the impact of specific promotions or events like food truck rallies or community gatherings.

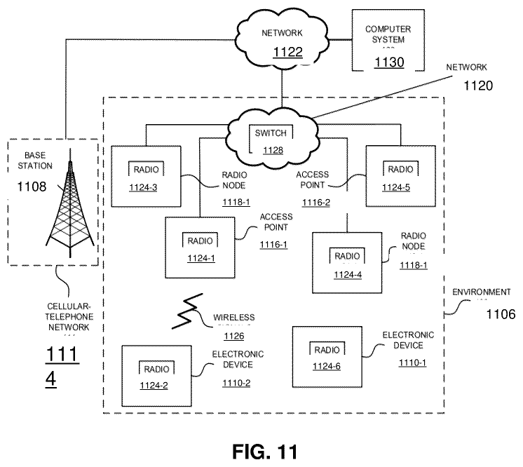

Finally, at block 1012, an artificial intelligence agent is developed specifically for the gourmet burger food truck based on the trained models. This AI agent continuously analyzes real-time data such as customer orders, feedback from social media platforms, and location-based trends to recommend menu updates, pricing adjustments, and strategic locations that maximize profitability and customer satisfaction. In summary, this structured approach illustrates how the system integrates new mobile food truck vendors, trains AI models using annotated and simulated data, validates their predictions against historical records, and deploys tailored AI agents to optimize operations and customer experiences in the competitive mobile food industry. In implementations of the general techniques for enhancing communication and data analysis capabilities within the mobile retail environment, the system is configured to gather and analyze comprehensive data. FIG. 11 extends this concept by presenting a block diagram illustrating an example of communication between one or more electronic devices in an environment. Moreover, these electronic devices may communicate via a variety of networks and protocols, ensuring data exchange and real-time updates for optimized route planning and delivery. This integration allows the system to dynamically adjust vendor operations and recommendations, enhancing the overall efficiency and profitability of mobile retail vendors based on real-time consumer intent and environmental factors.

We now describe some embodiments of the general techniques. FIG. 11 presents a block diagram illustrating an example of communication between electronic devices 1110-1 and/or 1110-2 (such as a cellular telephone, a portable electronic device, or another type of electronic device, etc.) in an environment 1106. Moreover, electronic devices 1110-1 and/or 1110-2 may optionally communicate via a cellular-telephone network 1114 (which may include a base station 1108), one or more access points 1116-1 and/or 1116-2 (which may communicate using Wi-Fi) in a wireless local area network (WLAN) and/or radio node 1118-1 (which may communicate using LTE or a cellular-telephone data communication protocol) in a small-scale network (such as a small cell). For example, radio node 1118-1 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 1108), one or more access points 1116-1 and/or 1116-2, and/or radio node 1118-1 may be included in one or more networks, such as: a WLAN, a small cell, a local area network (LAN) and/or a cellular-telephone network. In some embodiments, one or more access points 1116-1 and/or 1116-2 may include a physical access point and/or a virtual access point that is implemented in software in an environment of an electronic device or a computer. For example, radio 1124-1 is connected to access point 1116-1. Radio 1124-2 is connected to electronic device 1110-2. Both radio 1124-3 and radio 1124-4 are connected to radio node 1118-1. Radio 1124-5 is connected to access point 1116-2, while radio 1124-6 is connected to electronic device 1110-1. Radio 1124-2 is configured to transmit one or more wireless signals 1126 to radio 1124-1.

Furthermore, electronic devices 1110-1 and/or 1110-2 may optionally communicate with computer system 1130 (which may include one or more computers or servers and which may be implemented locally or remotely to provide storage and/or analysis services) using a wired communication protocol (such as Ethernet) via network 1120 and/or 1122. Note that networks 1120 and 1122 may be the same or different networks. For example, networks 1120 and/or 1122 may be a LAN, an intranet, or the Internet. In some embodiments, the wired communication protocol may include a secured connection over transmission control protocol/Internet protocol (TCP/IP) using hypertext transfer protocol secure (HTTPS). Additionally, in some embodiments, network 1120 may include one or more routers and/or switches (such as switch 1128).

Electronic devices 1110-1 and/or 1110-2 and/or computer system 1130 may implement at least some of the operations in the security techniques. Notably, as described further below, a given one of the electronic devices (such as electronic device 1110-1) and/or computer system 1130 may perform at least some of the analysis of data associated with the electronic device 1110-1 (such as first detection of a new peripheral, communication via an interface, a change to software or program instructions, a change to a DLL, a change to stored information, etc.) acquired by an agent executing in an environment (such as an operating system) of the electronic device 1110-1, and may provide data and/or first-detection information to computer system 1130.

Initially, when a new mobile vendor joins, our system updates the database to encompass their products and services comprehensively. Alongside this, we adjust their operational constraints, which can vary dynamically over different time periods such as daily, weekly, or monthly cycles. This ensures that the system is always aligned with current vendor capabilities and operational parameters. The training process commences with phase 1, where annotated training begins utilizing existing data while aiming to maximize expected Return on Investment (ROI). This phase focuses on leveraging known data to train and refine models that predict optimal actions and decisions for the mobile vendors in various scenarios. For instance, historical sales data and customer behavior patterns are used to train the system to predict the most profitable products to feature at different times of the day. Moving to phase 2, the system introduces environmental events to further refine the navigation capabilities of the selected vendor population within the market landscape. These events add complexity and nuance, simulating real-world challenges and opportunities that vendors might encounter. By exposing the trained models to these simulated environments, the system identifies and selects the best-performing agents capable of navigating through these complexities effectively.

As noted above, the outcomes of phase 2 undergo rigorous testing against annotated historical records of events and intentions. This testing ensures that the selected agents not only perform well in simulated environments but also align with past real-world scenarios. If the agents pass this validation phase, they are officially generated and integrated into the operational database. Once deployed, these agents serve in real-time to guide mobile vendors throughout their daily operations. They make dynamic decisions based on real-time data inputs such as customer foot traffic, weather conditions, and current market trends. For example, an agent might dynamically adjust pricing strategies based on competitor activities and customer demand patterns throughout the day.

In some embodiments, the apparatus and techniques described above are implemented in a system including one or more integrated circuit (IC) devices (also referred to as integrated circuit packages or microchips), such as the processing system described above with reference to FIGS. 1-11. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

Implementations of the disclosed system and method for an intelligent dynamic marketplace provide numerous technical benefits that address the limitations of conventional logistics and marketplace systems. By leveraging neuroevolution (NE) algorithms, the system evolves neural network topologies in real-time, enabling scalable, adaptive learning that eliminates the need for retraining from scratch. This results in faster model optimization, reduced computational overhead, and greater responsiveness to dynamic market conditions. Unlike traditional reinforcement learning systems that rely on fixed value functions, the NE-based system evolves behavior directly, allowing it to perform efficiently in high-dimensional, continuous, and non-Markovian environments without requiring discretization or explicit modeling of rewards. The system integrates a personalized AI agent for each mobile vendor, dynamically generated through evolutionary learning and refined using real-time data such as customer intentions, market behavior, inventory status, and external events including traffic and weather conditions. These agents support predictive decision-making and autonomously optimize vendor routing, inventory prioritization, and marketing strategies to maximize return on investment (ROI) under changing conditions.

Additionally, the system employs a parallel processing architecture combining CPU and GPU resources to execute low-latency event-driven updates. Each relevant event, such as a shift in consumer behavior, a vendor's updated inventory, or an environmental disruption, triggers a real-time recalculation of recommended actions and routes. This improves operational efficiency and ensures high service levels with minimal delay. The system's integration with cloud infrastructure allows for secure, scalable ingestion and processing of both structured and unstructured data, including public cloud feeds for environmental, geospatial, and transactional information. The use of recurrent neural networks (RNNs) and long short-term memory (LSTM) networks enables the system to account for temporal dependencies in user behavior and market trends, thereby enhancing the accuracy of intent predictions and enabling anticipatory logistics. Furthermore, the combination of annotated historical records and simulated environmental training events strengthens the AI agent's ability to navigate complex real-world conditions.

By synthesizing data from cloud sources, mobile interfaces, and vendor systems, the system maintains a continuously updated model of consumer intent, product demand, and operational constraints. The use of a business logic communications processor facilitates seamless distribution of vendor-specific operational directives and coordination across the marketplace ecosystem. The result is a robust, adaptive infrastructure that supports dynamic and distributed decision-making, personalized recommendations, and real-time system optimization. Overall, the system achieves concrete technological improvements in processing efficiency, predictive accuracy, data security, and resource utilization, making it well-suited for modern mobile commerce applications that demand responsive, intelligent, and scalable logistical capabilities.

The system described herein offers a concrete technical solution to the challenges faced by mobile retail platforms, particularly in dynamic marketplace environments where routing, inventory control, and consumer engagement must be optimized in real time. Unlike conventional systems that rely on static models, pre-defined logic, or retrained machine learning algorithms, the disclosed system employs a neuroevolution (NE) engine that evolves neural network architectures dynamically. This continuous evolution process enables the system to adapt to non-Markovian, temporally sensitive, and high-dimensional data without restarting model training, resulting in significantly reduced computational overhead and latency. By processing concurrently received request data, event data, and user intent data, the NE engine generates predictive evolutionary models tailored to specific market conditions. These models are then used to generate AI agents that do not merely forecast behavior but drive concrete hardware-level decisions.

The AI agents control operational aspects of mobile vendor systems, including dispatch scheduling, GPS-based routing, and in certain implementations, regulation of onboard systems such as refrigeration and battery management based on predicted arrival times and expected demand. These outputs directly affect physical world activities, demonstrating a specific and practical application beyond mere data processing or abstract idea manipulation. Furthermore, the integration of multiple data streams, including structured product requests, public cloud event data, and probabilistically weighted user intent, into a unified neuroevolutionary framework provides a novel improvement over conventional approaches to dynamic logistics planning. The result is a system that not only improves the accuracy and relevance of mobile vendor recommendations but also enhances the operational efficiency of the underlying computing infrastructure by reducing the need for full model retraining and supporting parallel inference across multiple vendor scenarios.

This technological advancement is particularly valuable in mobile environments where infrastructure is limited, bandwidth is constrained, and timely decisions are essential. The NE engine's ability to maintain continuity in network topology evolution ensures persistent learning and adaptation, addressing a technical problem inherent to conventional reinforcement learning systems. Additionally, the AI agent processor interfaces directly with business logic processors and edge devices, enabling the system to issue executable commands that translate predictive models into actionable deployment plans. These include optimized vendor locations, adjusted timing for deliveries, and tailored product offerings based on evolving market behavior. The system therefore offers a technical improvement in both the functioning of the computer system and the performance of mobile retail networks.

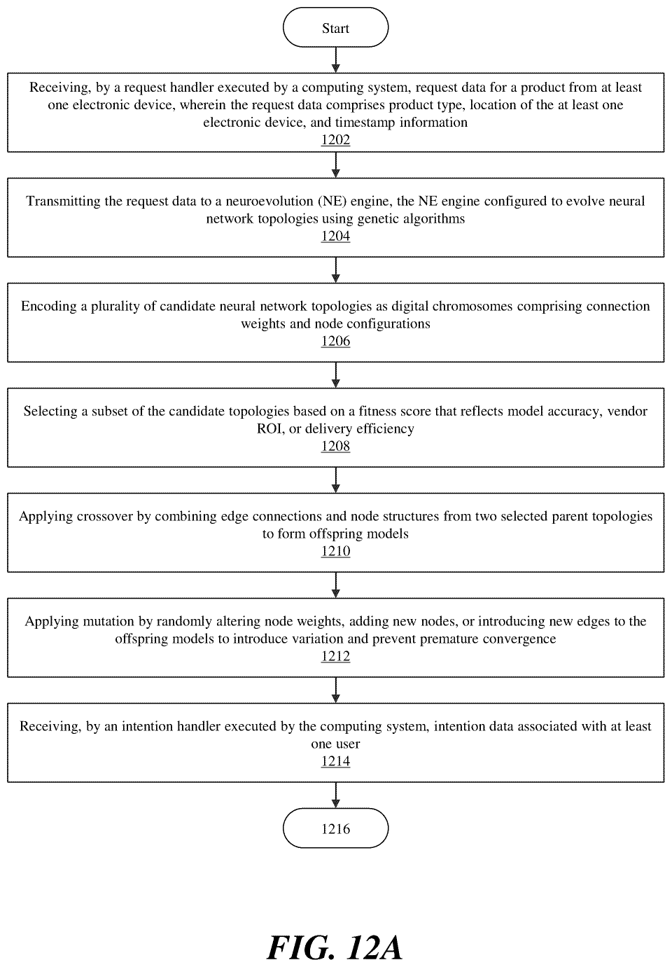

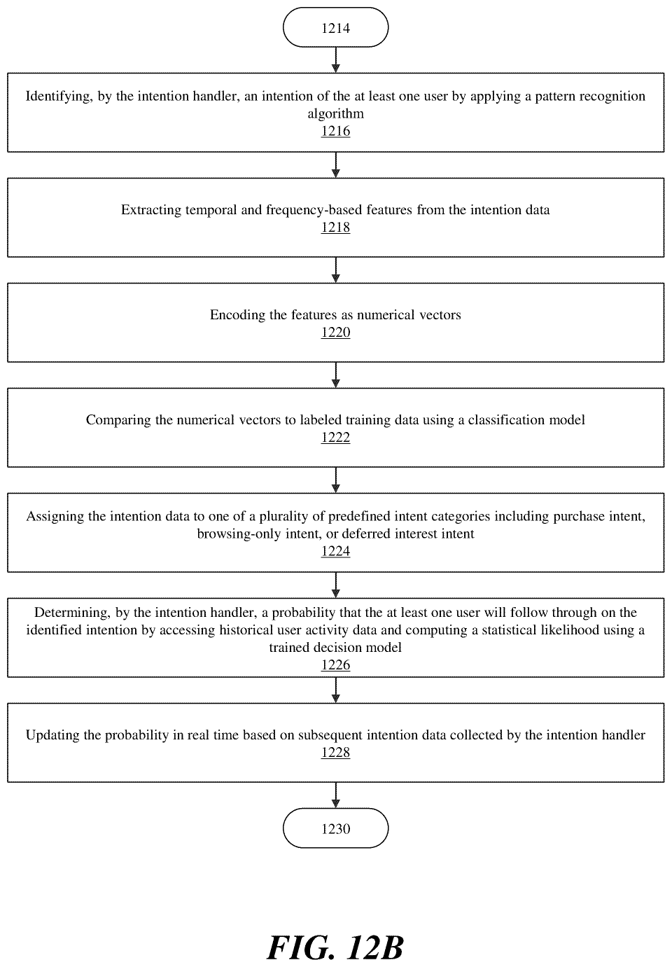

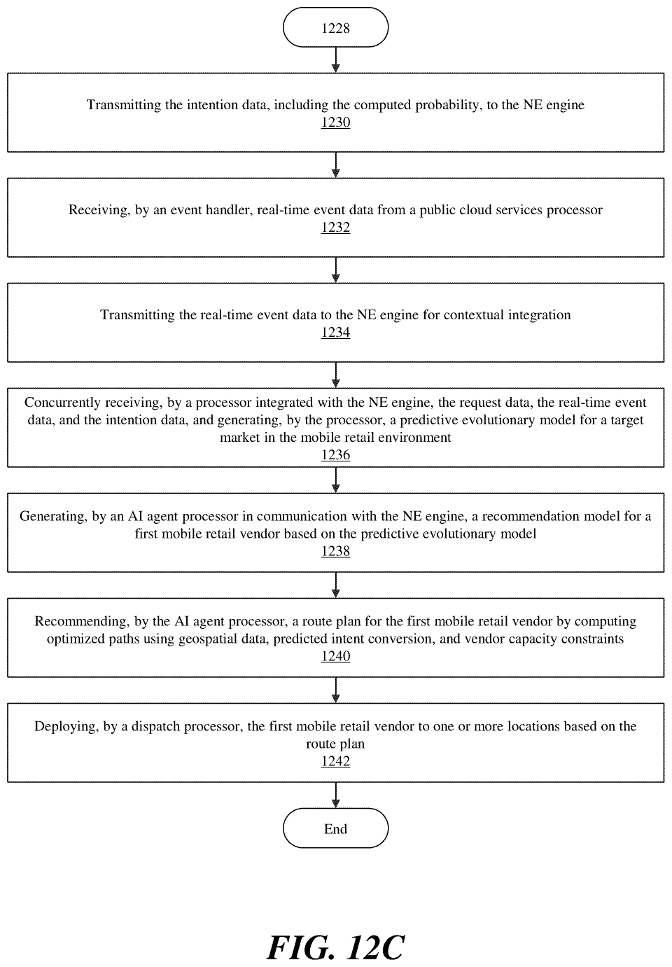

Referring to FIG. 12A, the method begins with the system receiving, at step 1202, product request data from at least one electronic device, such as a mobile phone or in-vehicle interface. The data may include a product type, geolocation of the device, and timestamp. For example, a user may request a food item through an application, and the request handler collects metadata related to the request context. At step 1204, the request data is transmitted to a neuroevolution (NE) engine that is configured to evolve neural network topologies using genetic algorithms. The NE engine processes the incoming data in real time to adaptively refine models that forecast market behavior and optimize mobile retail deployment. At step 1206, the NE engine encodes a population of candidate neural networks as digital chromosomes. These chromosomes represent different configurations of nodes and weighted edges that define the topology and function of each network.

At step 1208, the NE engine selects a subset of these candidate topologies based on a fitness score, which may be calculated according to prediction accuracy, delivery efficiency, or vendor ROI. At step 1210, the NE engine applies a crossover operation, combining elements such as node structures and edge weights from two selected parent models to generate one or more offspring models. At step 1212, the NE engine applies mutation by randomly modifying aspects of the neural network such as connection weights, the addition of new nodes, or the insertion of new connections. These genetic operations help promote variation across the network population and reduce the risk of premature convergence. At step 1214, an intention handler executed by the computing system receives intention data associated with at least one user. This data is typically generated through user interactions with a digital storefront or commerce application. Turning to FIG. 12B, which continues from step 1214, the system proceeds to identify user intention. At step 1216, the intention handler applies a pattern recognition algorithm to the received intention data. At step 1218, the system extracts relevant temporal and frequency-based features from the data, including metrics such as page view duration, scrolling behavior, and interaction sequence timing.

At step 1220, the extracted features are encoded as numerical vectors, which are then passed to a classifier at step 1222. This classifier compares the input to labeled training data using a trained model such as a neural network or support vector machine. At step 1224, the intention data is classified into one of several predefined intent categories, including purchase intent, browsing-only intent, and deferred interest intent. At step 1226, the system computes a probability that the user will follow through on the identified intention. This is done by referencing historical behavioral data and applying a trained decision model. At step 1228, the system updates the probability score in real time as further interaction data becomes available, reflecting the dynamic nature of user behavior. Proceeding to FIG. 12C, the system transmits the intention data, including the computed probability, to the NE engine at step 1230. At step 1232, an event handler receives real-time event data from a public cloud services processor. This may include data feeds related to traffic, weather, and local events.

At step 1234, the real-time event data is transmitted to the NE engine for contextual integration. This step ensures that the predictive models produced by the engine account for external environmental factors that may influence consumer behavior or vendor logistics. At step 1236, the NE engine concurrently receives the request data, the real-time event data, and the intention data, and uses these inputs to generate a predictive evolutionary model of the target market. This model captures spatial and temporal patterns of likely consumer demand. At step 1238, an AI agent processor, which is in communication with the NE engine, generates a recommendation model for a first mobile retail vendor based on the predictive model. The recommendation may include optimized product inventory levels, preferred customer engagement strategies, and timing suggestions. At step 1240, the AI agent processor computes a route plan for the mobile retail vendor. The route plan is based on geospatial constraints, predicted conversion rates, and operational capacity constraints. For instance, it may avoid areas with known road closures while targeting locations with high forecasted demand. At step 1242, a dispatch processor deploys the first mobile retail vendor based on the generated route plan. Deployment may involve transmitting routing instructions to a vehicle navigation system or issuing dispatch commands through a vendor-facing interface. Together, FIGS. 12A through 12C illustrate an integrated and technically grounded system that adapts to consumer behavior and environmental data in real time to improve efficiency and responsiveness in mobile retail operations.

In one embodiment, a computer-implemented method is provided for optimizing route planning and product delivery in a mobile retail environment. The method integrates multiple real-time data sources, such as user behavior, product requests, and environmental conditions, through a neuroevolution (NE) engine configured to dynamically evolve neural networks for predictive marketplace optimization. The system enables automated deployment of mobile vendors in response to forecasted demand, behavioral intent, and logistical constraints. The system includes a request handler that receives product request data from at least one user device, such as a smartphone, tablet, wearable, or in-vehicle interface. The request data may include a product identifier, such as a stock keeping unit (e.g., SKU #9321), the geolocation of the user (e.g., latitude 34.0522, longitude −118.2437), a timestamp, a session ID or anonymized device ID, and context information indicating how the request was generated, such as a one-click reorder, barcode scan, or voice command. For example, a user located near a university campus requests “bottled water” via a grocery delivery app. The request handler processes the input, extracts the relevant parameters, and transmits the data to the NE engine for analysis.

The request handler may monitor for new requests using either a polling mechanism (e.g., querying every two seconds) or an event-driven architecture based on publish/subscribe protocols such as Kafka or MQTT. In some implementations, the request data is aggregated or filtered prior to transmission to reduce bandwidth or improve throughput. Simultaneously, an intention handler receives behavioral data from the user's interaction with the platform. This may include event logs such as the number of product views, dwell time on each item, cart modifications, filter or sort usage, search refinements, and exit signals. For instance, a user might spend 45 seconds viewing organic apples, apply a price filter, add the product to their cart, and then remove it. These behaviors are converted into numerical vectors using extracted features like click frequency, inter-click time, and scroll depth. The system then classifies the user's intent using a pre-trained model such as a support vector machine or recurrent neural network, and assigns the session to one of several predefined intent categories, such as high likelihood of purchase, exploratory browsing, or price-sensitive behavior. For example, a user who repeatedly searches for milk, views multiple brands, and filters by discount is categorized as having price-comparison intent with a calculated 78 percent probability of follow-through. This probability score is updated dynamically based on additional behavior, such as revisiting the item or initiating checkout.

At the same time, an event handler receives real-time environmental data from a public cloud services processor. This includes weather alerts, traffic congestion, scheduled local events, and demographic or economic indicators. For example, traffic APIs may report heavy congestion along a proposed delivery route, while a weather API signals a thunderstorm warning. A local concert or school dismissal time may also be detected and associated with expected shifts in foot traffic or demand density. Each data stream is timestamped and location-tagged, and then forwarded to the NE engine as structured input.

The NE engine receives the request data, intention data, and event data concurrently. These inputs are encoded as features and provided to a population of candidate neural network models. Each model in the population is represented as a digital genome or chromosome, which encodes its topology, node activation functions, and edge weights. The NE engine applies a fitness function to evaluate how well each candidate performs in predicting demand clusters, maximizing delivery efficiency, and aligning with high-probability intent zones. For instance, fitness may be calculated as a weighted sum of delivery time reduction, predicted sales conversion, and system resource optimization.

The NE engine performs genetic operations such as crossover and mutation. In crossover, substructures of two parent models are combined, such as merging edge weights and hidden layer nodes, to form a new offspring model. In mutation, the engine randomly modifies a candidate model by adding a new node, changing an edge weight, or creating a new connection. For example, a connection weight may be altered from 0.42 to 0.58 during a mutation operation, wherein the system selects a synaptic connection between two nodes such as between an input node and a hidden layer node, and applies a perturbation algorithm to adjust the weight. This operation is typically executed using a seeded pseudo-random number generator that produces a delta value, which is added or subtracted from the existing weight. The modified weight is stored in an adjacency matrix or connection list that represents the neural topology in memory. This modification directly affects the numerical output of the downstream node, as the weighted sum used in the forward propagation step of the neural network will reflect the updated parameter. Such perturbations are constrained within acceptable bounds to maintain numerical stability and prevent saturation in activation functions.

In another example, a new hidden node with a tanh activation function may be inserted between two existing layers. This structural mutation involves dynamically modifying the internal representation of the neural network topology by allocating memory space for a new node and updating the connection mappings to route output from an upstream node to the new tanh node, and then from that tanh node to the original downstream node. The insertion process includes initializing the new node's incoming and outgoing weights, commonly using Xavier or He initialization techniques to ensure balanced signal propagation. The tanh activation function is assigned by referencing an activation function registry or lookup table maintained by the NE engine. This activation function introduces non-linearity into the model, allowing the network to better approximate complex, non-linear relationships in the input data. The updated topology is then evaluated by re-running the model against a validation set to determine whether the mutation has improved or degraded performance, which in turn influences the model's fitness score in the evolutionary selection process.

Additional structural changes may include the addition of skip connections, duplication of existing node pathways, or dynamic pruning of underutilized edges. These architectural variations are applied in a context-aware manner, guided by feedback from prior generations of model performance. For instance, if a tanh node consistently improves classification accuracy for high-intent user behavior when inserted after a ReLU layer, the mutation strategy may bias toward reusing similar insertions in subsequent generations. This feedback-driven approach reflects an adaptive learning process, wherein the architecture of the model evolves in response to observed outcomes, rather than being statically predefined.

These examples underscore the system's ability to perform non-trivial, structured transformations to both the numerical and topological configuration of the neural networks using machine-executed algorithms. Such transformations are carried out at the memory and instruction level within a physical computing system, enabling real-time reconfiguration of models based on live market data and user behavior inputs.

This evolved network is passed to an AI agent processor that constructs a recommendation model for a specific mobile vendor. The model specifies which product categories should be prioritized, suggested pricing strategies, optimal time windows for deployment, and proposed marketing messages. For example, the AI agent may recommend that Vendor A deploy to a farmers market between 1:30 PM and 4:00 PM, carry 60 percent produce and 40 percent drinks, and use the message “Cool off with fresh juice” if the temperature exceeds 85 degrees Fahrenheit.

In some embodiments, the route plan is generated by the AI agent processor using pathfinding algorithms such as A* or Dijkstra's algorithm. The street graph is dynamically weighted using real-time traffic data, elevation changes, road closures, and vendor-specific constraints such as vehicle refrigeration requirements. In one example, the system recommends that a refrigerated truck visit a hospital campus at 2:15 PM and a park-and-ride facility at 3:10 PM, where clusters of users with high intent scores have been detected. In particular, may operate on a dynamically constructed and weighted street graph. This street graph is a directed graph data structure in which each node represents a geospatial location (such as an intersection, address, or delivery zone), and each edge represents a possible travel path between those nodes (e.g., a road segment). The graph is maintained in memory and continuously updated in real time based on incoming environmental and logistical data.

The edge weights of the graph are not static; instead, they are dynamically computed using multiple contextual variables. First, real-time traffic data is acquired from public or commercial APIs (e.g., Google Maps Traffic or HERE services), providing current speed, congestion levels, and incident reports for each road segment. These metrics are mapped to graph edges using unique road segment identifiers or GPS coordinate interpolation, and are used to increase edge weights for slower or blocked routes, thereby discouraging selection during the route optimization process.

In addition to traffic, elevation data is factored into the weighting process. Road segments with steep inclines or declines may be assigned increased cost values due to energy consumption or braking wear, particularly for heavier vehicles. Elevation data is typically derived from geographic information system (GIS) datasets or digital elevation models (DEMs), which are queried by the AI processor during edge weight calculation. Road closures, both scheduled and emergent, are also incorporated. These are represented in the graph by either removing the affected edge (making the path impassable) or by assigning a prohibitively high weight to simulate inaccessibility. Closure data may originate from municipal feeds, crowd-sourced platforms, or in-field vendor reports. Vendor-specific constraints are encoded as cost functions or eligibility filters within the route planning algorithm. For instance, if the mobile retail vendor is a refrigerated truck, the system ensures that the route avoids locations without permissible idling zones or with known refrigeration noise restrictions. In such cases, disallowed locations are either excluded from the graph or tagged with constraint flags that the algorithm uses to prune infeasible paths.

Once the graph is fully constructed and weighted, the AI agent processor executes the selected pathfinding algorithm. If using A*, the system selects a heuristic function—such as the Euclidean or Manhattan distance between the current node and the destination node—that estimates the remaining travel cost. A* explores paths in priority order based on the sum of the actual cost from the start node and the estimated cost to the goal node, thus accelerating convergence. Dijkstra's algorithm may alternatively be used when heuristic data is not available or when all edge weights are treated with equal importance. The algorithm computes the shortest-cost path through the graph from a starting location to one or more target locations. The output is a route plan, which consists of an ordered list of waypoints or GPS coordinates, annotated with estimated arrival times and instructions. These timestamps are derived by factoring in predicted travel time based on real-time traffic and constraints.

In one example, the AI agent processor identifies two high-priority delivery zones: a hospital campus where a cluster of high-intent users (as determined by the intention handler) is present, and a park-and-ride facility near a commuter transit hub. Based on current traffic and operating constraints, the system calculates that the earliest optimal visit time for the hospital is 2:15 PM, accounting for congestion around shift changes, and for the park-and-ride facility at 3:10 PM, aligned with expected commuter arrivals. These decisions are not hardcoded but are the result of live optimization based on multidimensional input and graph traversal logic. The generated route plan is then packaged into a dispatch object and transmitted to the vendor interface or autonomous control system using a secure communication protocol, enabling the mobile vendor to execute the plan in the field.

A dispatch processor then initiates deployment of the mobile vendor. In manual cases, a push notification is sent to the vendor's application or dashboard. The message may read: “Proceed to 4201 Main Street. Estimated foot traffic: 50 users. Inventory: 75 percent beverages, 25 percent snacks. Predicted sales window: 2:00-3:30 PM.” In more automated settings, such as semi-autonomous delivery vehicles or mobile kiosks, the dispatch processor transmits operational instructions via a low-latency protocol such as MQTT or WebSockets. Commands may include navigation routes, refrigeration activation times, display messages, or pricing changes.

By continuously evolving its decision models in response to changing user behavior, real-time environmental conditions, and request patterns, the system offers a technical improvement over static rule-based routing systems. It enables adaptive, efficient, and intelligent deployment of mobile retail resources. This system reduces delivery delays, maximizes vendor profitability, and enhances the user experience by ensuring the right products arrive at the right time and location. The integration of real-time data processing, machine learning via neuroevolution, and hardware-level deployment control results in a practical, technically grounded application of advanced artificial intelligence in a mobile retail context.

The disclosed method is implemented on a distributed computing system comprising at least one request handler, a neuroevolution engine, an intention handler, an event handler, an AI agent processor, and a dispatch processor, all communicatively coupled via electronic interfaces or networked service buses. Each of these modules performs a discrete technical function that contributes to optimizing route planning and deployment in a mobile retail environment. The method begins when the request handler receives request data for a product from at least one electronic device. The request data includes structured digital fields such as product type identifiers, timestamps, device IDs, and geospatial coordinates derived from GPS modules. The request handler includes memory buffers and a parsing engine that extracts this data and packages it in a machine-readable format, such as a JSON or protocol buffer object, before forwarding it to the neuroevolution engine.

The neuroevolution engine comprises a processing module configured to evolve neural network topologies using genetic algorithms. The engine receives the structured request data and encodes it into a format suitable for integration into the input layers of candidate neural networks. Each candidate network is encoded as a digital chromosome comprising a series of numerical values that represent network structure, including node connectivity matrices, edge weights, activation function parameters, and node types. These chromosomes are manipulated through genetic operations including crossover, where topological features from two parent models are recombined, and mutation, where numerical weights or structural edges are perturbed or new nodes are added. For instance, crossover may involve the recombination of hidden layer node arrangements from two selected networks, while mutation may randomly change a synaptic weight from 0.3 to 0.7 or introduce a new ReLU-activated node between two existing layers. These operations are governed by mutation rates and selection pressures determined by a fitness evaluation loop.

Fitness evaluation is performed by scoring each candidate network using a composite performance metric that may incorporate forecast accuracy, model generalization error, resource consumption, and an economic utility function reflecting vendor return on investment. The evolutionary cycle iterates over multiple generations, with the fittest models retained or further evolved in successive rounds. These operations are executed on a compute substrate comprising CPUs, GPUs, or cloud-based ML accelerators, depending on implementation context.

In parallel, an intention handler receives behavioral interaction data from user devices, including mouse activity, screen touch patterns, dwell time, and navigation paths within a retail interface. This data is preprocessed through a time-series feature extraction module that calculates both temporal and frequency-domain features such as inter-event intervals, visit recency, burst patterns, and engagement variance. These features are encoded into numerical vectors through normalization and feature hashing routines. The resulting vectors are compared to a labeled training dataset using a classification model, which may take the form of a random forest, multilayer perceptron, or support vector machine. The classifier assigns the user's behavior to an intent category such as active purchase, passive browsing, or delayed interest.

A decision model subsequently accesses historical user behavior data and calculates a follow-through probability. This model may be trained using logistic regression or gradient-boosted trees and receives the classified intent and current session features as input. For example, if a user frequently returns to a specific product type and demonstrates high engagement density, the model may assign a high follow-through probability. The probability is not static; it is dynamically updated as new user events are recorded in real time. This real-time update is facilitated through streaming event listeners and low-latency model re-evaluation pipelines.

The intention data, including the classified intent and computed probability, is transmitted to the neuroevolution engine and becomes part of the evolving model's input feature set. Concurrently, an event handler retrieves real-time contextual data from public cloud service APIs, including weather conditions, traffic data, and local event calendars. This information is normalized and timestamped, then integrated with the NE engine's input data stream.

The NE engine receives, in parallel, the product request data, the intention data, and the contextual event data, and uses this information to generate a predictive evolutionary model. This model forecasts spatial demand concentration, product interest likelihood, and optimal retail vendor coverage zones. The model parameters include dynamic weight vectors, layer depths, and context-aware adjustment coefficients, which are optimized over time through repeated exposure to new data inputs and continued genetic adaptation.

An AI agent processor receives the predictive evolutionary model and computes a recommendation for a specific mobile retail vendor. This recommendation includes an optimal set of target customers, suggested inventory adjustments, and a spatiotemporally optimized route. Route planning is executed using graph-based algorithms such as A* or Dijkstra, where node weights are derived from real-time road conditions, predicted customer conversion rates, and vendor-specific constraints such as delivery window limits or refrigeration needs.

Once the route is finalized, a dispatch processor initiates deployment by composing a dispatch message that includes route instructions, timing, and inventory directives. The dispatch message is sent over a secure channel using an encrypted messaging protocol and may be received by a mobile application operated by the vendor or an autonomous delivery vehicle control system.

The end-to-end method involves multiple algorithmic transformations of incoming data, evolution of complex machine learning models using genetic algorithms, and concrete deployment actions executed by connected devices. The method enables real-time, adaptive optimization of mobile retail deployment and reflects a specific improvement in the functioning of computer systems as applied to the field of mobile commerce logistics.

### EXAMPLES

Clause 1. A dynamic marketplace system based on store and warehouse mobility, comprising: a neuroevolution (NE) engine; an electronic device; a request handler electrically connected to the electronic device and to the NE engine, and wherein the request handler to receive request data for a product from the electronic device, and wherein the request handler to transmit the request data to the NE engine; a data storage system is electrically connected to the NE engine; a public cloud services processor; an event handler electrically connected to the public cloud services processor and to the NE engine, and wherein the event handler to receive real-time event data from the public cloud services processor, and wherein the event handler to transmit the real-time event data to the NE engine; an intentions handler electrically connected to the NE engine and configured to receive intention data from a user to identify an intent of the user, and generate a probability that the user will carry out the intent based on a historical follow-through of the user, and wherein the intentions handler to transmit the intention data to the NE engine; a processor integrated with the NE engine configured to: in response to concurrently receiving the request data, the real-time event data, and the intention data, generate a predictive evolutionary model for a target market in the dynamic marketplace, the predictive evolutionary model configured to trigger one or more real-world control actions; an AI agent processor in communication with the NE engine configured to: generate a recommendation model for a first mobile retail vendor based on the predictive evolutionary model; recommend a route plan for the first mobile retail vendor; and automatically initiate deployment of the first mobile retail vendor to one or more physical locations based on the route plan, including transmitting control instructions to a dispatching system for execution.

Clause 2. The dynamic marketplace system based on store and warehouse mobility of clause 1, wherein the AI agent processor configured to: detect a presence of a second mobile retail vendor and update a vendor database with one or more goods or services offered by the second mobile retail vendor; generate a recommendation model for the second mobile retail vendor based on an updated predictive evolutionary model; recommend an updated route plan for the second mobile retail vendor; and deploy the second mobile retail vendor based the recommendation model of the first mobile retail vendor and the updated predictive evolutionary model of the second mobile retail vendor.

Clause 3. The dynamic marketplace system based on store and warehouse mobility of clause 1, wherein the AI agent processor is a vendor.

Clause 4. The dynamic marketplace system based on store and warehouse mobility of clause 1, wherein the public cloud services processor to integrate one or more public events in one or more operation zones.

Clause 5. The dynamic marketplace system based on store and warehouse mobility of clause 4, wherein the one or more public events is based on at least a traffic limitation, a transit time, or a public event.

Clause 6. The dynamic marketplace system based on store and warehouse mobility of clause 1, wherein the data storage system to store one or more of historical data, a customer preference, a market trend, or an operational constraint.

Clause 7. The dynamic marketplace system based on store and warehouse mobility of clause 1, wherein the AI agent processor to dynamically adjust vendor operations and recommendations based on real-time changes in user preferences, event dynamics, geographical locations, and vendor-specific performance metrics.

Clause 8. The dynamic marketplace system based on store and warehouse mobility of clause 1, wherein the dynamic marketplace system is based on a dynamic return on a dynamic (ROI) model related to the intent of the user.

Clause 9. The dynamic marketplace system based on store and warehouse mobility of clause 8, wherein the intent of the user is determined when the intentions handler detects an opening of one or more applications.

Clause 10. The dynamic marketplace system based on store and warehouse mobility of clause 8, wherein the intent of the user is determined when the intentions handler detects a predetermined length of time that is spent on the product in an application.

Clause 11. The dynamic marketplace system based on store and warehouse mobility of clause 8, wherein the intent of the user is determined when the intentions handler detects a selected future product.

Clause 12. The dynamic marketplace system based on store and warehouse mobility of clause 8, wherein the AI agent processor to continuously update and refine the dynamic ROI model based on real-time data and historical performance metrics.

Clause 13. The dynamic marketplace system based on store and warehouse mobility of clause 8, wherein the AI agent processor to analyze consumer intent to predict a profitable location and time for a vendor to operate.

Clause 14. The dynamic marketplace system based on store and warehouse mobility of clause 8, wherein the AI agent processor to adjust vendor routes and schedules in response to detected changes in consumer intent.

Clause 15. The dynamic marketplace system based on store and warehouse mobility of clause 8, further comprising: one or more public or private events are automatically detected and factored into the dynamic ROI model to optimize vendor placement.

Clause 16. The dynamic marketplace system based on store and warehouse mobility of clause 8, further comprising: a past behavior is used to generate personalized recommendations for future product offerings and locations.

Clause 17. The dynamic marketplace system based on store and warehouse mobility of clause 8, further comprising: a proximity of multi-dwelling units is considered to estimate potential customer density and optimize vendor positioning.

Clause 18. The dynamic marketplace system based on store and warehouse mobility of clause 8, further comprising: a median income in a location is used to tailor product offerings and pricing strategies for vendors.

Clause 19. The dynamic marketplace system based on store and warehouse mobility of clause 8, further comprising: a delivery range based on proximity selected by a vendor to influence one or more of the route plan and target locations.

Clause 20. The dynamic marketplace system based on store and warehouse mobility of clause 8, further comprising: a vendor schedule is optimized based on a time of day or night and on expected customer activity patterns.

Clause 21. The dynamic marketplace system based on store and warehouse mobility of clause 8, further comprising: a merchandise or service type to be factored into the dynamic ROI model to align vendor offerings with consumer demand in one or more differing locations.

Clause 22. The dynamic marketplace system based on store and warehouse mobility of clause 8, further comprising: a past ROI of a predetermined vendor is used to refine and enhance a future recommendation or an operational strategy.

Clause 23. The dynamic marketplace system based on store and warehouse mobility of clause 8, further comprising: one or more real-time notifications or updates are transmitted to vendors based on an updated analysis of consumer intent or one or more market conditions.

Clause 24. A computer-implemented method for optimizing route planning and delivery in a mobile retail environment, comprising: receiving, by a request handler, request data for a product from at least one electronic device; transmitting the request data to a neuroevolution (NE) engine; monitoring a new request for a product; receiving, by an intention handler, intention data associated with at least one user; identifying an intention of the intention data of a user; determining a probability that the user will follow through on the intention based on a historical follow-through of the user; updating the probability based on subsequent intention data collected by the intention handler; transmitting the intention data to the NE engine; receiving, by an event handler, real-time event data from a public cloud services processor, and transmitting the real-time event data to the NE engine; concurrently receiving, by a processor integrated with the NE engine, at least the request data, the real-time event data, and the intention data, generating a predictive evolutionary model for a target market in the mobile retail environment; generating, by an AI agent processor in communication with the NE engine, a recommendation model for a first mobile retail vendor based on the predictive evolutionary model; recommending a route plan for the first mobile retail vendor; and deploying the first mobile retail vendor to one or more locations based on the route plan.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A dynamic marketplace system based on store and warehouse mobility, comprising:
a neuroevolution (NE) engine;
an electronic device;
a request handler electrically connected to the electronic device and to the NE engine, and
wherein the request handler to receive request data for a product from the electronic device, and
wherein the request handler to transmit the request data to the NE engine;
a data storage system is electrically connected to the NE engine;
a public cloud services processor;
an event handler electrically connected to the public cloud services processor and to the NE engine, and
wherein the event handler to receive real-time event data from the public cloud services processor, and
wherein the event handler to transmit the real-time event data to the NE engine;
an intentions handler electrically connected to the NE engine and configured to receive intention data from a user to identify an intent of the user, and
generate a probability that the user will carry out the intent based on a historical follow-through of the user, and
wherein the intentions handler to transmit the intention data to the NE engine;
a processor integrated with the NE engine configured to:
in response to concurrently receiving the request data, the real-time event data, and the intention data, generate a predictive evolutionary model for a target market in the dynamic marketplace, the predictive evolutionary model configured to trigger one or more real-world control actions;
an AI agent processor in communication with the NE engine configured to:
generate a recommendation model for a first mobile retail vendor based on the predictive evolutionary model;
recommend a route plan for the first mobile retail vendor; and
automatically initiate deployment of the first mobile retail vendor to one or more physical locations based on the route plan, including transmitting control instructions to a dispatching system for execution.

2. The dynamic marketplace system based on store and warehouse mobility of claim 1, wherein the AI agent processor configured to:
detect a presence of a second mobile retail vendor and update a vendor database with one or more goods or services offered by the second mobile retail vendor;
generate a recommendation model for the second mobile retail vendor based on an updated predictive evolutionary model;
recommend an updated route plan for the second mobile retail vendor; and
deploy the second mobile retail vendor based the recommendation model of the first mobile retail vendor and the updated predictive evolutionary model of the second mobile retail vendor.

3. The dynamic marketplace system based on store and warehouse mobility of claim 1, wherein the AI agent processor is a vendor.

4. The dynamic marketplace system based on store and warehouse mobility of claim 1, wherein the public cloud services processor to integrate one or more public events in one or more operation zones.

5. The dynamic marketplace system based on store and warehouse mobility of claim 4, wherein the one or more public events is based on at least a traffic limitation, a transit time, or a public event.

6. The dynamic marketplace system based on store and warehouse mobility of claim 1, wherein the data storage system to store one or more of historical data, a customer preference, a market trend, or an operational constraint.

7. The dynamic marketplace system based on store and warehouse mobility of claim 1, wherein the AI agent processor to dynamically adjust vendor operations and recommendations based on real-time changes in user preferences, event dynamics, geographical locations, and vendor-specific performance metrics.

8. The dynamic marketplace system based on store and warehouse mobility of claim 1, wherein the dynamic marketplace system is based on a dynamic return on a dynamic (ROI) model related to the intent of the user.

9. The dynamic marketplace system based on store and warehouse mobility of claim 8, wherein the intent of the user is determined when the intentions handler detects an opening of one or more applications.

10. The dynamic marketplace system based on store and warehouse mobility of claim 8, wherein the intent of the user is determined when the intentions handler detects a predetermined length of time that is spent on the product in an application.

11. The dynamic marketplace system based on store and warehouse mobility of claim 8, wherein the intent of the user is determined when the intentions handler detects a selected future product.

12. The dynamic marketplace system based on store and warehouse mobility of claim 8, wherein the AI agent processor to continuously update and refine the dynamic ROI model based on real-time data and historical performance metrics.

13. The dynamic marketplace system based on store and warehouse mobility of claim 8, wherein the AI agent processor to analyze consumer intent to predict a profitable location and time for a vendor to operate.

14. The dynamic marketplace system based on store and warehouse mobility of claim 8, wherein the AI agent processor to adjust vendor routes and schedules in response to detected changes in consumer intent.

15. The dynamic marketplace system based on store and warehouse mobility of claim 8, further comprising:
one or more public or private events are automatically detected and factored into the dynamic ROI model to optimize vendor placement.

16. The dynamic marketplace system based on store and warehouse mobility of claim 8, further comprising:
a past behavior is used to generate personalized recommendations for future product offerings and locations.

17. The dynamic marketplace system based on store and warehouse mobility of claim 8, further comprising:
a proximity of multi-dwelling units is considered to estimate potential customer density and optimize vendor positioning.

18. The dynamic marketplace system based on store and warehouse mobility of claim 8, further comprising:
a median income in a location is used to tailor product offerings and pricing strategies for vendors.

19. The dynamic marketplace system based on store and warehouse mobility of claim 8, further comprising:
a delivery range based on proximity selected by a vendor to influence one or more of the route plan and target locations;
a vendor schedule optimized based on a time of day or night and on expected customer activity patterns;
a merchandise or service type factored into the dynamic ROI model to align vendor offerings with consumer demand in one or more differing locations.
a past ROI of a predetermined vendor used to refine a future recommendation or an operational strategy; and
one or more real-time notifications or updates configured to be transmitted to one or more vendors based on an updated analysis of consumer intent or one or more market conditions.

20. A computer-implemented method for optimizing route planning and delivery in a mobile retail environment, comprising:
receiving, by a request handler executed by a computing system, request data for a product from at least one electronic device, wherein the request data comprises product type, location of the at least one electronic device, and timestamp information;
transmitting the request data to a neuroevolution (NE) engine, the NE engine configured to evolve neural network topologies using genetic algorithms, including: encoding a plurality of candidate neural network topologies as digital chromosomes comprising connection weights and node configurations; selecting a subset of the candidate topologies based on a fitness score that reflects model accuracy, vendor ROI, or delivery efficiency; applying crossover by combining edge connections and node structures from two selected parent topologies to form offspring models; and applying mutation by randomly altering node weights, adding new nodes, or introducing new edges to the offspring models to introduce variation and prevent premature convergence;
monitoring, by the request handler, a new request for a product by continuously polling or subscribing to data updates from the at least one electronic device;
receiving, by an intention handler executed by the computing system, intention data associated with at least one user, wherein the intention data includes application interaction events, product browsing time, or cart additions;
identifying, by the intention handler, an intention of the at least one user by applying a pattern recognition algorithm comprising: extracting temporal and frequency-based features from the intention data; encoding the features as numerical vectors; comparing the numerical vectors to labeled training data using a classification model; and assigning the intention data to one of a plurality of predefined intent categories including purchase intent, browsing-only intent, or deferred interest intent;
determining, by the intention handler, a probability that the at least one user will follow through on the identified intention by accessing historical user activity data and computing a statistical likelihood using a trained decision model;
updating the probability in real time based on subsequent intention data collected by the intention handler, including changes in interaction patterns or abandonment signals;
transmitting the intention data, including the computed probability, to the NE engine;
receiving, by an event handler, real-time event data from a public cloud services processor, wherein the real-time event data includes geolocation-tagged information related to traffic, weather, and public events;
transmitting the real-time event data to the NE engine for contextual integration;
concurrently receiving, by a processor integrated with the NE engine, the request data, the real-time event data, and the intention data, and generating, by the processor, a predictive evolutionary model for a target market in the mobile retail environment, wherein the NE engine performs neuroevolution by selecting and evolving neural network candidates that maximize a fitness function based on historical sales performance, predicted demand, and mobility constraints;
generating, by an AI agent processor in communication with the NE engine, a recommendation model for a first mobile retail vendor based on the predictive evolutionary model, wherein the recommendation model includes vendor-specific delivery timing, product inventory adjustments, and customer engagement strategies;
recommending, by the AI agent processor, a route plan for the first mobile retail vendor by computing optimized paths using geospatial data, predicted intent conversion, and vendor capacity constraints; and
deploying, by a dispatch processor, the first mobile retail vendor to one or more locations based on the route plan, wherein the dispatch processor transmits executable routing instructions to a vehicle control interface or vendor-facing application.
